(19) United States
(12) Patent Application Publication
(10) Pub. No.: US 2008/0126407 A1
(43) Pub. Date: May 29, 2008

(54) System-data-architecture management system, system-data-architecture management process, and computer-readable medium storing system-data-architecture management program

(75) Inventors: Junji Shimaoka, Kawasaki (JP); Masahiko Kamo, Yokohama (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/650,692

(22) Filed: Jan. 5, 2007

(30) Foreign Application Priority Data
Aug. 31, 2006 (JP) JP 2006-236719

(51) Int. Cl. G06F 17/30

(52) U.S. Cl. 707/103 Y; 707/E17.001; 707/E17.055

(57) ABSTRACT

A system, process, and computer-readable medium storing a system-data-architecture management program which enable mutual transformation between modeling information represented by a graph structure with model elements and a design specification in a tabular form. When a request for synchronization of the modeling information with a design-data table is received, a table synchronization unit sets a value corresponding to an attribute value of an attribute to be synchronized which is set in a model element to be synchronized, in a cell located in a row or column with which the model element is associated. When a request for synchronization of the design-data table with the modeling information is received, a model synchronization unit sets an attribute value of an attribute corresponding to a cell located in a row or column, in a model element being to be synchronized and corresponding to an identifier set to the row or column.

### CROSS-REFERENCE TO RELATED APPLICATIONS

This application is based upon and claims the benefits of priority from the prior Japanese Patent Application No. 2006-236719, filed on Aug. 31, 2006, the entire contents of which are incorporated herein by reference.

### BACKGROUND OF THE INVENTION

1) Field of the Invention

The present invention relates to a system-data-architecture management system, a system-data-architecture management process, and a computer-readable medium storing a system-data-architecture management program which manage data for use in a computer system, and in particular to a system-data-architecture management system, a system-data-architecture management process, and a computer-readable medium storing a system-data-architecture management program which manage modeling information and a design-data table, where the modeling information diagrammatically represents relationships between data items used in a computer system, and the design-data table represents the data items in a tabular form.

2) Description of the Related Art

Currently, when a computer system is developed, modeling information on the computer system is defined in the beginning stage of the development. In the modeling information, relationships between data items used in programs are represented. For example, the modeling information can be defined by using the Unified Modeling Language (UML). The modeling information described in UML is useful for understanding relationships between data items.

In addition, generally, a design specification is prepared separately from the modeling information. The design specification includes information which indicates, for example, what data item is to be inputted in each of a great number of defined data entries. In many cases, users who use a computer system refer to the design specification, and confirm that the design specification covers all data items necessary for performing activities by use of the computer system.

In the case where both of the modeling information and the design specification are produced during development of a computer system, the modeling information and the design specification are required to be consistent with each other all the times. For example, when a data class is added to the modeling information, details of the data corresponding to the data class must be reflected in the design plan. However, it is very laborious and time-consuming to manually keep consistency between the modeling information and the design specification. In addition, since the manual operation is likely to cause human errors, the consistency between the modeling information and the design specification cannot be assured.

In order to solve the above problem, techniques for producing a design specification on the basis of modeling information have been proposed. For example, Japanese Unexamined Patent Publication No. 2005-258561 discloses a technique for producing a design specification described in the form of text data, on the basis of modeling information, by analyzing design information including a design model described in UML.

Although the modeling tools used in product design generally handle the modeling information having a graph structure, the working efficiency in browsing or editing the modeling information is increased by handling the design information in a tabular form. For example, when a list of data items in a data model or screen-displayed items in a GUI (Graphical User Interface)-screen model is indicated in a tabular form, it is possible to easily check whether or not a design omission occurs. Therefore, design-data tables are frequently used, in particular, in the design documents.

Nevertheless, there is currently no modeling tool which provides a function of automatically synchronizing modeling information and a design-data table in a format unique to a user. Even when the technique disclosed in Japanese Unexamined Patent Publication No. 2005-258561 is used, only the text data is produced on the basis of the modeling information, and the design specification in a tabular form cannot be produced from the modeling information.

Therefore, currently, the user performs the operations of manually transferring the modeling information to the design-data table, and constructing modeling information on the basis of the contents of the design-data table. In such a case, the modeling information and the design-data table are separately managed. Thus, an enormous amount of man-hour is required for performing operations of producing the design specification, which include the above operations of reflecting the contents of the design-data table in the modeling information and vice versa.

### SUMMARY OF THE INVENTION

The present invention is made in view of the above problems, and the object of the present invention is to provide a system-data-architecture management system, a system-data-architecture management process, and a computer-readable medium storing a system-data-architecture management program which enable mutual conversion between modeling information managed in a graph structure and a design specification in a tabular form.

In order to accomplish the above object, according to the first aspect of the present invention, a system-data-architecture management system for managing modeling information and a design-data table is provided, where the modeling information diagrammatically represents relationships between data items used in a computer system, and the design-data table represents the data items in a tabular form. The system-data-architecture management system comprises: a modeling-information storing unit which stores the modeling information, where the modeling information defines a data architecture by using model elements, attribute values can be set in the model elements on an attribute-by-attribute basis, and an identifier for uniquely identifying each of the model elements is set to the model element; a table storing unit for storing a design-data table which has at least one row and at least one column, and in which the model elements are associated with only the at least one row, or only the at least one column, or both the at least one row and the at least one column, cells are arrayed in the at least one row or the at least one column with which the model elements are associated, and values corresponding to attributes related to the model elements are set in the cells; a mapping-definition storing unit which stores a mapping definition including a synchronized-element definition, a synchronized-attribute definition, and a table-structure definition, where the synchronized-element definition defines all or a part of the model elements as one or more model elements to be synchronized with the design-data table, the synchronized-attribute definition defines all or a part of the attributes as one or more attributes to be synchronized with the design-data table, and the table-structure definition defines a table structure used in tabulating values corresponding to the one or more attributes for each of the one or more model elements; a table synchronization unit which extracts the one or more model elements from the modeling information on the basis of the synchronized-element definition, determines, according to the table-structure definition, one or more of the at least one row and the at least one column in the design-data table with which the one or more model elements are respectively associated, sets one or more identifiers of the one or more model elements to the one or more of the at least one row and the at least one column, extracts one or more first attribute values of all or a first part of the one or more attributes set in the one or more model elements, and sets one or more values corresponding to the one or more first attribute values in one or more cells arrayed in the one or more of the at least one row and the at least one column, in accordance with the table-structure definition, when a request for synchronization of the design-data table with the modeling information is inputted into the computer; and a model synchronization unit which determines the one or more of the at least one row and the at least one column according to the table-structure definition, determines all or a second part of the one or more attributes to correspond to the one or more cells, according to the table-structure definition, determines one or more second attribute values of all or the second part of the one or more attributes on the basis of values set in the one or more cells, and sets one of the one or more second attribute values of all or the second part of the one or more attributes corresponding to each of the one or more cells in one of the one or more model elements so that the cell is located in one of the one or more of the at least one row and the at least one column to which an identifier corresponding to the one of the one or more model elements is set, when a request for synchronization of the modeling information with the design-data table is inputted into the computer.

In addition, in order to accomplish the aforementioned object, according to the second aspect of the present invention, a system-data-architecture management process which manage modeling information and a design-data table is also provided, where the modeling information diagrammatically represents relationships between data items used in a computer system, and the design-data table represents the data items in a tabular form. The system-data-architecture management process comprises the steps of: (a) preparing in advance in the computer, a modeling-information storing unit which stores the modeling information, where the modeling information defines a data architecture by using model elements, attribute values can be set in the model elements on an attribute-by-attribute basis, and an identifier for uniquely identifying each of the model elements is set to the model element, a table storing unit for storing a design-data table which has at least one row and at least one column, and in which the model elements are associated with only the at least one row, or only the at least one column, or both the at least one row and the at least one column, cells are arrayed in the at least one row or the at least one column with which the model elements are associated, and values corresponding to attributes related to the model elements are set in the cells, and a mapping-definition storing unit which stores a mapping definition including a synchronized-element definition, a synchronized-attribute definition, and a table-structure definition, where the synchronized-element definition defines all or a part of the model elements as one or more model elements to be synchronized with the design-data table, the synchronized-attribute definition defines all or a part of the attributes as one or more attributes to be synchronized with the design-data table, and the table-structure definition defines a table structure used in tabulating values corresponding to the one or more attributes for each of the one or more model elements; (b) performing, by a table, synchronization unit, first processing for synchronizing the design-data table with the modeling information when a request for synchronization of the design-data table with the modeling information is inputted into the computer, where the first processing includes the substeps of, (b1) extracting the one or more model elements from the modeling information on the basis of the synchronized-element definition, (b2) determining, according to the table-structure definition, one or more of the at least one row and the at least one column in the design-data table with which the one or more model elements are respectively associated, (b3) setting one or more identifiers of the one or more model elements to the one or more of the at least one row and the at least one column, (b4) extracting one or more first attribute values of all or a first part of the one or more attributes set in the one or more model elements, and (b5) setting one or more values corresponding to the one or more first attribute values in one or more cells arrayed in the one or more of the at least one row and the at least one column, in accordance with the table-structure definition; and (c) performing, by a model synchronization unit, second processing for synchronizing the modeling information with the design-data table when a request for synchronization of the modeling information with the design-data table is inputted into the computer, where the second processing includes the substeps of, (c1) determining the one or more of the at least one row and the at least one column according to the table-structure definition, (c2) determining all or a second part of the one or more attributes to correspond to the one or more cells, according to the table-structure definition, (c3) determining one or more second attribute values of all or the second part of the one or more attributes on the basis of values set in the one or more cells, and (c4) setting one of the one or more second attribute values of all or the second part of the one or more attributes corresponding to each of the one or more cells in one of the one or more model elements so that the cell is located in one of the one or more of the at least one row and the at least one column to which an identifier corresponding to the one of the one or more model elements is set.

Further, in order to accomplish the aforementioned object, according to the third aspect of the present invention, a computer-readable medium storing a system-data-architecture management program which is executed by a computer and makes the computer realize a system-data-architecture management system for managing modeling information and a design-data table is also provided, where the modeling information diagrammatically represents relationships between data items used in a computer system, and the design-data table represents the data items in a tabular form. When the system-data-architecture management program is executed by a computer, the computer realizes the aforementioned system-data-architecture management system according to the first aspect of the present invention.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a schematic diagram illustrating the basic construction of a system-data-architecture management system according to the present invention.

FIG. 2 is a diagram illustrating an example of a hardware construction of a computer used in a system-data-architecture management system in an embodiment of the present invention.

FIG. 3 is a block diagram illustrating the functions of the system-data-architecture management system in the embodiment of the present invention.

FIG. 4 is a diagram illustrating an example of a modeling-information set.

FIG. 5 is a diagram illustrating an example of a template of a design-data table.

FIG. 6 is a diagram illustrating an example of a mapping definition.

FIG. 7 is a diagram illustrating a displayed design-data table.

FIG. 8 is a flow diagram indicating processing for reflecting modeling information in a design-data table.

FIG. 9 is a flow diagram indicating processing for synchronizing a table-storing directory with model elements.

FIG. 10 is a flow diagram indicating processing for synchronizing a book with a book-corresponding element.

FIG. 11 is a flow diagram indicating processing for synchronizing a worksheet with a sheet-corresponding element.

FIG. 12 is a flow diagram indicating processing for reflecting the contents of design-data tables in modeling information.

FIG. 13 is a flow diagram indicating processing for synchronizing model elements with a table-storing directory.

FIG. 14 is a flow diagram indicating processing for synchronizing a book-corresponding element with a book.

FIG. 15 is a flow diagram indicating processing for synchronizing a sheet-corresponding element with a worksheet.

FIG. 16 is a diagram illustrating a design-data table in the list format.

FIG. 17 is a diagram illustrating a design-data table in the matrix format.

FIG. 18 is a diagram indicating dependency relationships between classes.

FIG. 19 is a diagram illustrating a modeling-information set corresponding to the diagram of FIG. 18.

FIG. 20 is a diagram illustrating a design-data table in which dependency relationships are indicated in the list format.

FIG. 21 is a diagram illustrating a design-data table in which dependency relationships are indicated in the matrix format.

FIG. 22 is a diagram illustrating an example of a template of a design-data table for indicating information in the matrix format.

FIG. 23 is a diagram illustrating a mapping definition for producing a design-data table in the matrix format.

FIG. 24 is a diagram illustrating an example of a design-data table in the matrix format.

FIGS. 25 and 26 are flow diagrams indicating processing for synchronizing a worksheet with a sheet-corresponding element.

FIGS. 27 and 28 are flow diagrams indicating processing for synchronizing a sheet-corresponding element with a worksheet.

FIG. 29 is a diagram for showing correspondence between a diagrammatic representation with nodes and an edge and an abstract model structure including a dependency relationship.

FIG. 30 is a diagram for showing correspondence between a UML class diagram and an abstract model structure indicating a generalization relationship.

### DESCRIPTION OF THE PREFERRED EMBODIMENTS

Preferred embodiments of the present invention will be explained below with reference to the accompanying drawings, wherein like reference numbers refer to like elements throughout. In addition, in the following explanations, the term “synchronization” means to reflect a change in modeling information in a design-data table, or to reflect a change in a design-data table in modeling information, and each function realized by executing an application program with a computer is referred to as an application.

### 1. Basic Construction

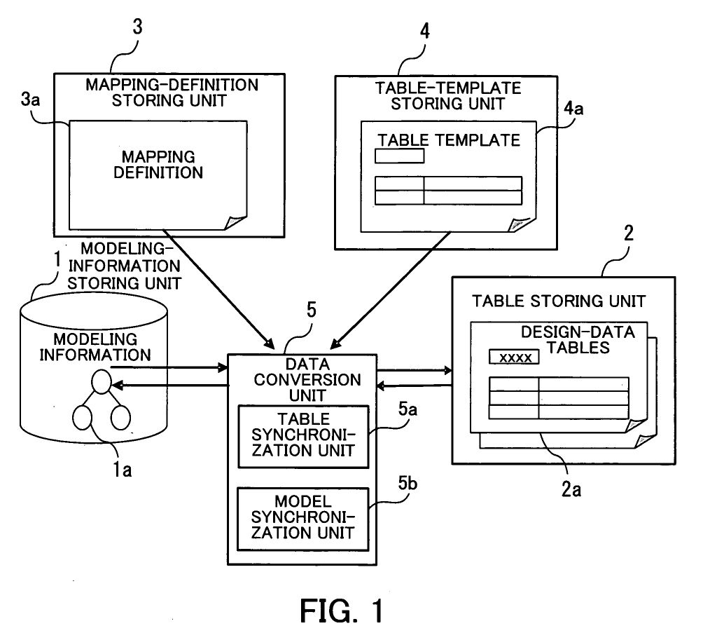

FIG. 1 is a schematic diagram illustrating the basic construction of a system-data-architecture management system according to the present invention, which is provided for managing modeling information 1a and design-data table 2a, where the modeling information 1a diagrammatically represents relationships between data items used in a computer system, and the design-data table 2a indicates the data items in a tabular form. The system-data-architecture management system of FIG. 1 has a modeling-information storing unit 1, a table storing unit 2, a mapping-definition storing unit 3, a table-template storing unit 4, and a data conversion unit 5.

The modeling-information storing unit 1 stores the modeling information 1a, which defines a data architecture by using a plurality of model elements, and the attribute values of attributes of the model elements can be set on an attribute-by-attribute basis. An identifier for uniquely identifying each model element is set in the model element.

The table storing unit 2 stores a design-data table 2a. In the design-data table 2a, one or more model elements are associated with only the at least one row, or only the at least one column, or both the at least one row and the at least one column, cells are arrayed in the at least one row or the at least one column with which the one or more model elements are associated, and a value corresponding to one of the attributes of each of the model elements is set in one of the cells which is located in a row or column with which the model element is associated. The value corresponding to the attribute may be the attribute value of the attribute, or a symbol indicating the presence or absence of the attribute.

The table-template storing unit 4 stores a table template 4a, which is a template used for producing a design-data table.

The mapping-definition storing unit 3 stores a mapping definition (definition of mapping) 3a. The mapping definition 3a includes a synchronized-element definition, a synchronized-attribute definition, and a table-structure definition. The synchronized-element definition defines one or more model elements to be synchronized with the design-data table 2a. The synchronized-attribute definition defines one or more attributes to be synchronized with the design-data table 2a. The table-structure definition defines a table structure used in tabulating one or more values corresponding to the one or more attributes to be synchronized, for the respective model elements to be synchronized.

The data conversion unit 5 comprises a table synchronization unit 5a and a model synchronization unit 5b. The table synchronization unit 5a reflects the modeling information 1a in the design-data table 2a when a request for synchronization of the design-data table 2a with the modeling information 1a is inputted. Specifically, the table synchronization unit 5a checks whether or not the design-data table 2a exists. When the design-data table 2a does not exist, the table synchronization unit 5a copies the table template 4a into the table storing unit 2, so that the copy becomes a design-data table. Next, the table synchronization unit 5a extracts the one or more model elements to be synchronized, from the modeling information 1a on the basis of the synchronized-element definition, and associates each of the extracted model elements with a row or column in the design-data table in accordance with the table-structure definition. In addition, the table synchronization unit 5a sets the identifier of each of the one or more model elements to the row or column with which the model element is associated. Further, the table synchronization unit 5a extracts one or more attribute values of one or more attributes which are to be synchronized and are currently set in the extracted model elements. Then, the table synchronization unit 5a sets one or more values corresponding to the extracted attribute values in one or more cells arrayed in the at least one row or at least one column with which the model elements to be synchronized are associated, in accordance with the table-structure definition.

When a request for synchronization of the modeling information 1a with the design-data table 2a is inputted into the system-data-architecture management system, the model synchronization unit 5b determines at least one row or column in the design-data table 2a with which the model elements to be synchronized are associated, on the basis of the table-structure definition. Next, the model synchronization unit 5b determines one or more attributes corresponding to one or more cells arrayed in the at least one row or column determined as above, on the basis of the table-structure definition. Further, the model synchronization unit 5b determines one or more attribute values of the one or more attributes corresponding to the one or more cells arrayed in the at least one row or column, on the basis of the values set in the one or more cells, and sets the one or more attribute values in one or more model elements being to be synchronized and corresponding to one or more identifiers set to the at least one row or column so that one of the one or more attribute values of one of the one or more attributes being to be synchronized and corresponding to each of the one or more cells located in a row or column to which an identifier is set is set in one of the one or more model elements corresponding to the identifier.

Thus, the system-data-architecture management system according to the present invention having the above construction operates as follows.

When a request for synchronization of the design-data table 2a with the modeling information 1a is inputted into the system-data-architecture management system, the table synchronization unit 5a recognizes at least one row or column in the design-data table 2a with which one or more model elements being to be synchronized and being extracted from the modeling information 1a are respectively associated, and the table synchronization unit 5a sets one or more identifiers of the one or more model elements to the at least one row or column with which the one or more model elements are associated. Further, the table synchronization unit 5a sets values corresponding to one or more attribute values of one or more attributes which are to be synchronized and are currently set in the extracted model elements, in the one or more cells arrayed in the at least one row or column with which the one or more model elements being to be synchronized and being extracted from the modeling information 1a are respectively associated.

When a request for synchronization of the modeling information 1a with the design-data table 2a is inputted into the system-data-architecture management system, the model synchronization unit 5b determines at least one row or column in the design-data table 2a with which one or more model elements to be synchronized are associated. Next, the model synchronization unit 5b determines one or more attributes corresponding to one or more cells arrayed in the at least one row or column, on the basis of the table-structure definition. Further, the model synchronization unit 5b determines one or more attribute values of the one or more attributes which are to be synchronized and correspond to the one or more cells, on the basis of one or more values set in the one or more cells, and sets the one or more attribute values in one or more model elements being to be synchronized and corresponding to one or more identifiers set to the at least one row or column so that one of the one or more attribute values of one of the one or more attributes being to be synchronized and corresponding to each of the one or more cells located in a row or column to which an identifier is set is set in one of the one or more model elements corresponding to the identifier.

As described above, according to the present invention, it is possible to reflect the modeling information 1a in the design-data table 2a, and the contents of the design-data table 2a in the modeling information 1a. Therefore, it is sufficient for the user to freely choose one of the modeling information 1a and the design-data table 2a which is suitable for editing the data architecture and the like, and it is possible to suppress occurrence of inconsistency between the modeling information 1a and the design-data table 2a.

### 2. First Embodiment

### 2.1 Hardware Construction

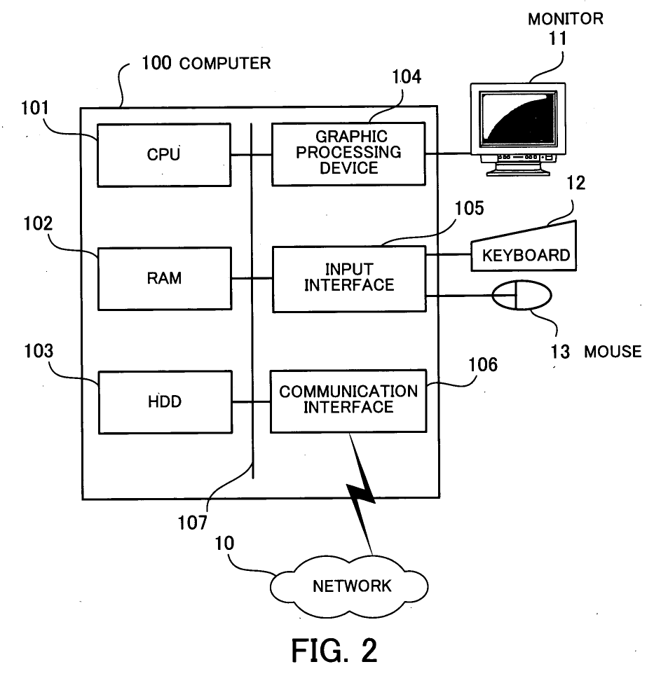

First, an example of a hardware construction of a computer used in a system-data-architecture management system in an embodiment of the present invention is explained with reference to FIG. 2, which is a diagram illustrating the example. The overall operations of the computer 100 illustrated in FIG. 2 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least portions of an OS (operating system) program and application programs which are executed by the CPU 101, as well as various types of data necessary for processing by the CPU 101. The HDD 103 stores the OS program and the application programs.

In addition, a monitor 11 is connected to the graphic processing device 104, which makes the monitor 11 display an image on a screen in accordance with an instruction from the CPU 101. A keyboard 12 and a mouse 13 are connected to the input interface 105, which transmits signals sent from the keyboard 12 and the mouse 13, to the CPU 101 through the bus 107.

The communication interface 106 is connected to the network 10. The communication interface 106 is provided for exchanging data with other computers through the network 10.

When the computer realizing the system-data-architecture management system has the above hardware construction, it is possible to realize processing functions in the embodiment of the present invention.

### 2.2 Functions of System

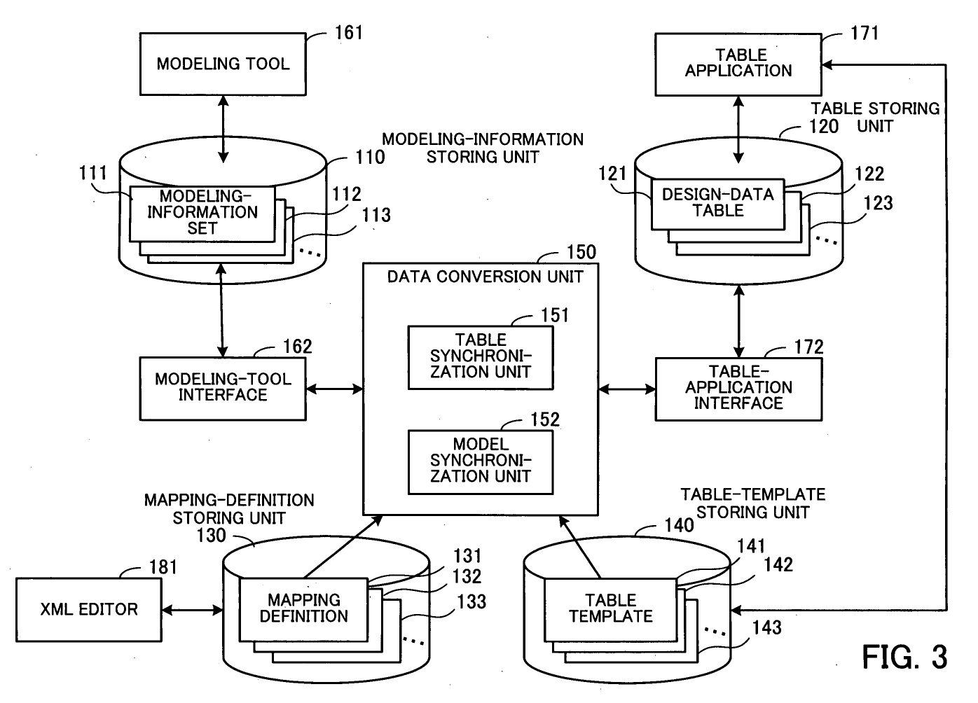

FIG. 3 is a block diagram illustrating the functions of the system-data-architecture management system according to the first embodiment of the present invention.

As illustrated in FIG. 3, according to the first embodiment, the computer 100 realizes a modeling-information storing unit 110, a table storing unit 120, a mapping-definition storing unit 130, a table-template storing unit 140, a data conversion unit 150, a modeling tool 161, a modeling-tool interface 162, a table application 171, a table-application interface 172, and an XML editor 181.

The modeling-information storing unit 110 has a function of a storage device which stores modeling-information sets 111, 112, 113 . . . . For example, a portion of the storage area of the HDD 103 is used for realizing the modeling-information storing unit 110. The modeling-information sets 111, 112, 113, . . . represent a data architecture which is used in a system under development and modeled in UML.

The table storing unit 120 has a function of a storage device which stores design-data tables 121, 122, 123 . . . . For example, a portion of the storage area of the HDD 103 is used for realizing the table storing unit 120. In the design-data tables 121, 122, 123, . . . , data items used in the system under development are listed in the form of a design-data table.

The mapping-definition storing unit 130 has a function of a storage device which stores mapping definitions 131, 132, 133, . . . . For example, a portion of the storage area of the HDD 103 is used for realizing the mapping-definition storing unit 130. The mapping definitions 131, 132, 133, . . . are described in the extensible Markup Language (XML), and include information indicating correspondences between the constituents of the design-data tables 121, 122, 123, . . . and the constituents (or the attribute values of the constituents) of the modeling-information sets 111, 112, 113, . . . , and information indicating how to use the table templates 141, 142, 143 . . . .

The table-template storing unit 140 has a function of a storage device which stores the table templates 141, 142, 143, . . . . For example, a portion of the storage area of the HDD 103 is used for realizing the table-template storing unit 140. The table templates 141, 142, 143, . . . are files in the forms of the design-data tables, and define the formats of the design-data tables which are to be synchronized with the modeling-information sets 111, 112, 113, . . . .

The data conversion unit 150 performs processing for synchronization between the modeling-information sets 111, 112, 113, . . . and the design-data tables 121, 122, 123, . . . . The processing functions of the data conversion unit 150 can be divided into a table synchronization unit 151 and a model synchronization unit 152. The table synchronization unit 151 synchronizes the design-data tables 121, 122, 123, . . . with the modeling-information sets 111, 112, 113, . . . , and the model synchronization unit 152 synchronizes the modeling-information sets 111, 112, 113, . . . with the design-data tables 121, 122, 123, . . . .

The modeling tool 161 is an application for producing the modeling-information sets 111, 112, 113, . . . in the forms of UML documents in response to manual input by the user. The modeling tool 161 stores the produced modeling-information sets 111, 112, 113, . . . in the modeling-information storing unit 110.

The modeling-tool interface 162 is an application program interface (API) for handling the modeling-information sets 111, 112, 113, . . . , and extracting information from the modeling-information sets 111, 112, 113, . . . .

The table application 171 is an application for producing the design-data tables 121, 122, 123, . . . in response to manual input by the user. For example, it is possible to use one of the spreadsheet programs as the table application 171. The table application 171 stores the produced design-data tables 121, 122, 123, . . . in the table storing unit 120. In this embodiment, the table templates 141, 142, 143, . . . are produced by using the table application 171. That is, the table application 171 can also produce the table templates 141, 142, 143, . . . in response to manual input of a command by the user, and stores the produced table templates 141, 142, 143, . . . in the table-template storing unit 140.

The files produced by the table application 171 are called books. Each book can include a plurality of worksheets, in which data can be registered in the form of a design-data table having rows and columns. Properties can be set to the books, worksheets, rows, and columns, respectively. In this embodiment, the table templates 141, 142, 143, . . . and the design-data tables 121, 122, 123, . . . are formed in books.

The table-application interface 172 is an API for handling the design-data tables 121, 122, 123, . . . , and extracting information from the design-data tables 121, 122, 123, . . . produced by the table application 171.

The XML editor 181 is an application for producing the mapping definitions 131, 132, 133, . . . in the forms of XML documents. The XML editor 181 has functions useful for producing XML documents. Since XML documents can be produced by using a text editor, the mapping definitions 131, 132, 133, . . . can also be produced by using one of the conventional text editors. The XML editor 181 stores the produced mapping definitions 131, 132, 133, . . . in the mapping-definition storing unit 130.

The user can make the system-data-architecture management system realize synchronization between modeling information and design-data tables by instructing the data conversion unit 150 to synchronize the design-data tables with the modeling information, or the modeling information with the design-data tables. When the user instructs the data conversion unit 150 to synchronize a design-data table with a modeling information set, it is necessary to designate an arbitrary model element (as a starting model element) in the modeling-information set, a mapping definition, a table template, and a table-storing directory. However, the designation of the table template is necessary only when a worksheet is newly produced. On the other hand, when the user instructs the data conversion unit 150 to synchronize a modeling information set with a design-data table, it is necessary to designate an arbitrary model element (as a starting model element) in the modeling information, a mapping definition, and a table-storing directory.

The table synchronization unit 151 or the model synchronization unit 152 in the data conversion unit 150 compares the modeling-information set containing the designated model element with the structure of a design-data table contained in the designated table-storing directory. It is determined which constituent element of the design-data table is to be compared with which model element included in the modeling-information set, in accordance with the descriptions in the mapping definition (e.g., a condition for extracting a model element in each layer in the design-data table).

When synchronization of a design-data table with a modeling information set is instructed, the table synchronization unit 151 deletes an unnecessary portion of the structure of the design-data table, and produces an additional structure which the current structure of the design-data table lacks. The manner of the production (e.g., the manner of assigning a name to the file) is determined in accordance with the descriptions in the mapping definition, and one or more identifiers of one or more model elements corresponding to the structure of the design-data table produced as above are embedded in the structure of the produced design-data table. In addition, the relationships between the attribute values in the modeling information set are reflected in the design-data table by transcription from the modeling information set into the design-data table.

When synchronization of a modeling information set with a design-data table is instructed, the model synchronization unit 152 deletes an unnecessary portion of model elements corresponding to the structure of the design-data table, and produces one or more additional model elements which the modeling information set lacks. The manner of the production (e.g., the types of the one or more additional model elements) is determined in accordance with the descriptions in the mapping definition, and one or more identifiers of the one or more additional model elements are embedded in the structure of the design-data table corresponding to the produced model elements. In addition, the relationships between attributes in the design-data table are reflected in the modeling information set by transcription from the design-data table into the modeling information.

### 2.3 Modeling Information

Hereinbelow, the data items stored in the modeling-information storing unit 110, the table storing unit 120, the mapping-definition storing unit 130, and the table-template storing unit 140 are explained.

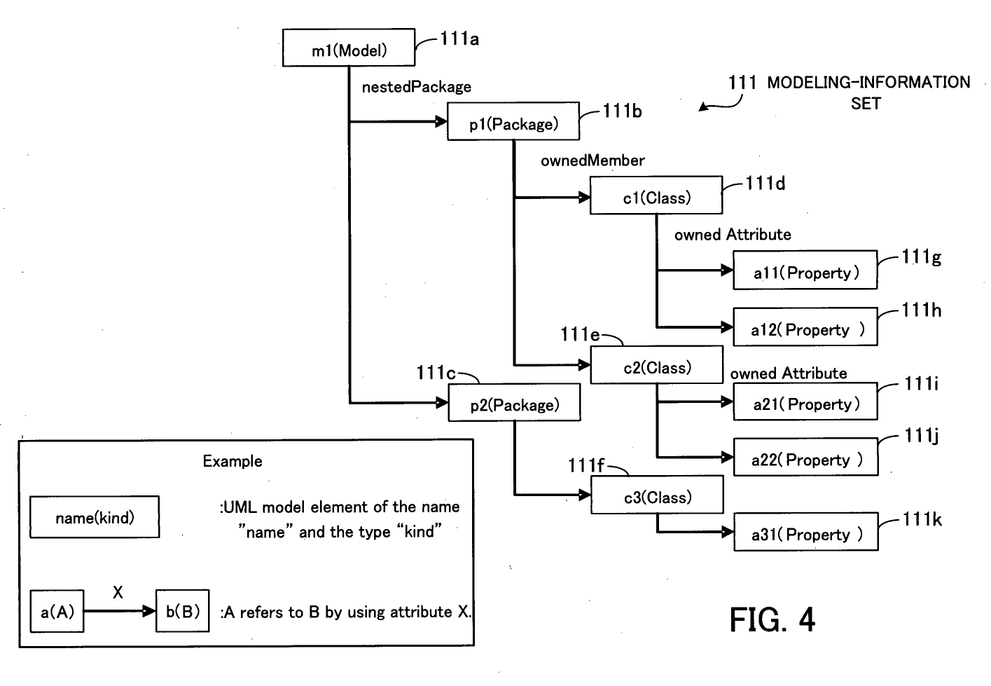

FIG. 4 is a diagram illustrating an example of the modeling-information set 111. The modeling-information set 111 is produced by using the drawing function or other editing functions of the modeling tool 161. In FIG. 4, the rectangles 111a to 111k represent model elements. In each of the rectangles, the character string outside the parentheses in each rectangle represents the name (the value of the “name” attribute) of the corresponding model element, and the character string in the parentheses in each rectangle represents the type of the corresponding model element. For example, the denotation “m1 (Model)” of the model element 111a means that the model element 111a is the “Model” type, and has the name “m1”. Although not shown in FIG. 4, when the modeling tool 161 produces the model elements 111a to 111k, an identifier (ID) is assigned to each of the model elements 111a to 111k for uniquely identifying each of the model elements 111a to 111k.

Each of the arrowed lines connecting two of the model elements 111a to 111k indicates a reference relationship between the model elements and the direction of the reference, and the character string indicated in the vicinity of each arrowed line shows an attribute, and the model element at the starting point (arrowtail) of the arrowed line refers to the model element at the forward end (arrowhead) of the arrowed line by using the attribute. For example, the model element 111a named “m1” has an attribute named “nestedPackage” (which means a set of model elements), and refers to the model element 111b named “p1” and the model element 111c named “p2” by the “nestedPackage” attribute. Each of the model elements 111a to 111k also has further attributes in addition to the attributes indicated in FIG. 4. Although not shown, the combination of the attributes differs according to the type of the model.

### 2.4 Table Template

Next, the table templates 141, 142, 143, . . . used for producing the design-data tables 121, 122, 123, . . . on the basis of the modeling-information set 111 illustrated in FIG. 4 are explained below.

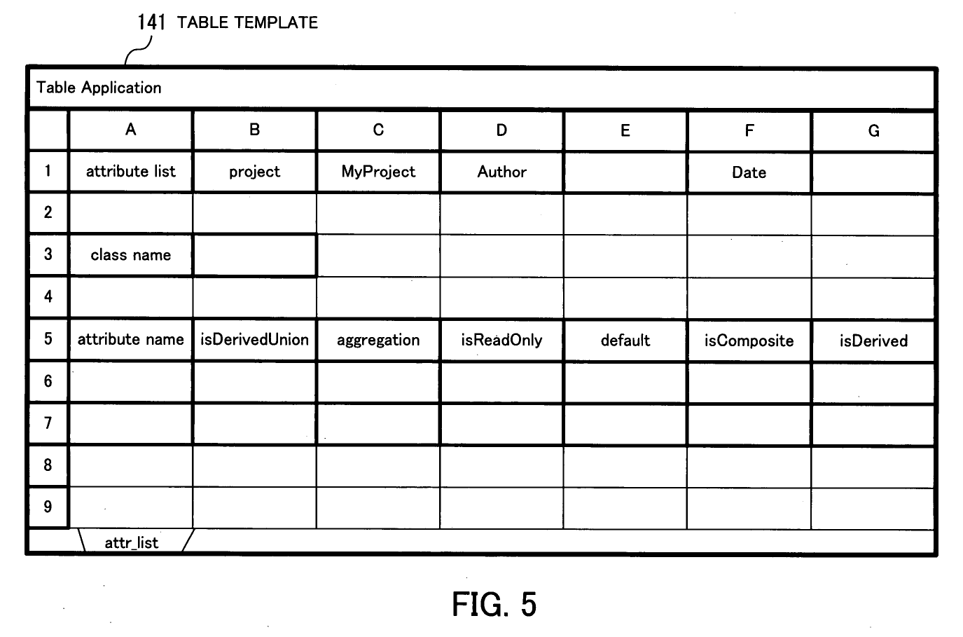

FIG. 5 is a diagram illustrating an example of a table template. The table template 141 is one of worksheets in a book produced by the table application 171 for defining the format of the design-data tables 121, 122, 123, . . . . In the table template 141 illustrated in FIG. 5, the first to seventh columns are respectively denoted by A to G.

The design-data tables 121, 122, 123, . . . produced by using the table template 141 illustrated in FIG. 5 indicate a list of data attributes. In the cell in row 1 column 1, the name of each of the produced design-data tables 121, 122, 123, . . . is indicated. The indication “project” in the cell in row 1 column 2 indicates that the name of the project (project name) is set in the adjacent cell (i.e., in row 1, column 3) on the right side of the cell in row 1 column 2, and the project name “MyProject” is set in the cell in row 1, column 3. The indication “Author” in the cell in row 1 column 4 indicates that the name of the author is set in the adjacent cell (i.e., in row 1, column 5) on the right side of the cell in row 1 column 4, i.e., the cell in row 1 column 5 is allocated for setting the date of preparation. The indication “Date” in the cell in row 1 column 6 indicates that the date of preparation is set in the adjacent cell (i.e., in row 1, column 7) on the right side of the cell in row 1 column 6, i.e., the cell in row 1 column 7 is allocated for setting the date of preparation.

The indication “class name” in the cell in row 3 column 1 indicates that the name of the class (class name) is set in the adjacent cell (i.e., in row 3, column 2) on the right side of the cell in row 3 column 1, i.e., the cell in row 3 column 2 is allocated for setting the name of the class (class name).

The indication “attribute name” in the cell in row 5 column 1 indicates that the attribute names of data are set in all the cells in column 1 under row 5. In the cells in row 5 columns 2 to 7, the names of information items on the data items corresponding to the attribute names are respectively set. The cells under row 5 in each of the columns 2 to 7 are respectively allocated for setting the values of the information item in the column corresponding to the attribute names. The columns 2 to 7 of each row after row 6 are allocated for setting each data value corresponding to the name of the item set in the same column of row 5.

The table template 141 is not changed unless the format of the design-data tables 121, 122, 123, . . . is changed. In rows 6 and 7, only the ruled lines are set. The ruled lines set in row 6 of the table template 141 are ruled lines which are to be set in the rows other than the first to fifth and bottom rows in the design-data tables 121, 122, 123, . . . , and the ruled lines set in row 7 of the table template 141 are ruled lines which are to be set in the bottom row in the design-data tables 121, 122, 123, . . . . When a row other than the bottom row is inserted in the design-data tables 121, 122, 123, . . . , the row 6 in the table template 141 including the ruled lines is copied into the design-data table.

### 2.5 Mapping Definition

Next, the mapping definition 131 for reflecting in the table template 141 the information defined in the modeling-information set 111 is explained below.

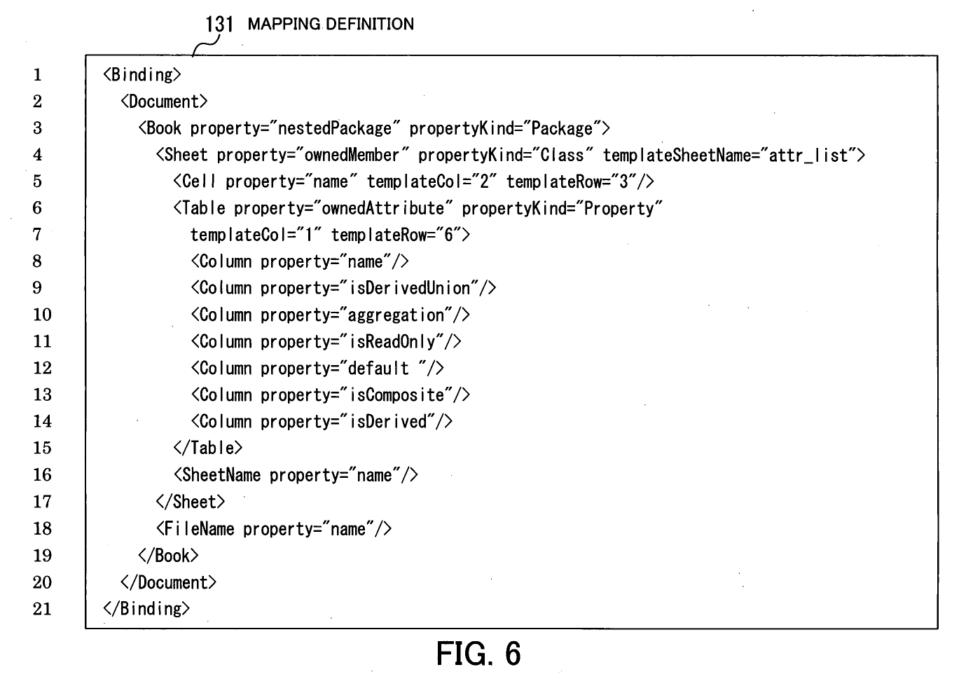

FIG. 6 is a diagram illustrating an example of the mapping definition. The mapping definition 131 describes the correspondences between the respective elements or the attribute values of the respective elements of the modeling information and the constituents of the design-data tables 121, 122, 123, . . . In addition, the mapping definition 131 also describes how to use the table template 141. In this embodiment, the mapping definition 131 is prepared as an XML document. The mapping definition 131 is not changed unless both of the table template per se and the manner of correspondence between the modeling information and the design-data tables are changed.

The <Book> element (in line 3) designates the manner of extraction, from the modeling information 111, of model elements corresponding to the design-data tables beginning with a model element designated as a starting model element in synchronization processing. The directory (table-storing directory) which stores the design-data tables 121, 122, 123, . . . is associated with the model element as the starting model element. The model element as the starting model element and the table-storing directory are designated by the user before the start of the synchronization processing.

In line 3, the attribute assignment “property=‘nestedPackage’ ” in the <Book> element designates that each of zero or more model elements referred to (looked up) by the “nestedPackage” attribute of the model element 111a (as the starting model element) corresponds to a design-data table, and the attribute assignment “propertyKind=‘Package’ ” in the <Book> element designates that the type of the model element added to the modeling-information set 111 by addition of a design-data table (storage of a new design-data table in the table-storing directory) is “Package”.

The <FileName> element (in line 18) designates the file name of the design-data table produced in the synchronization processing. In line 18, the attribute assignment “property=‘name’ ” in the <FileName> element designates that the value of the “name” attribute of a model element corresponding to the design-data table is used as the file name when the file of the design-data table is produced. At this time, the extension is a predetermined character string. For example, in the case where the table application 171 is Microsoft Excel (which is a registered trademark of Microsoft Corporation), the extension is “.xls”.

The <Sheet> element (in line 4) designates the manner of extraction of a model element corresponding to a worksheet from the model elements corresponding to the design-data table extracted as designated in the <Book> element. In line 4, the attribute assignment “property=‘ownedMember’” in the <Sheet> element designates that each of zero or more model elements referred to by the “ownedMember” attribute of the model element corresponding to the design-data table corresponds to a worksheet, and the attribute assignment “propertyKind=‘Class’ ” in the <Sheet> element designates that the type of the model element added to the modeling information by addition of a worksheet is “Class”. In addition, the attribute assignment “templateSheetName=‘attr_list’ ” in the <Sheet> element designates that the table template to be used is obtained from a book for table templates, and has a sheet name “attr_list”.

The <SheetName> element (in line 16) designates the name of the worksheet produced in the synchronization processing. In line 16, the attribute assignment “property=‘ownedMember’ ” in the <SheetName> element designates that the sheet name is produced on the basis of the value of the “name” attribute of the model element corresponding to the worksheet.

The <Cell> element (in line 5) designates what attribute value of the model element corresponding to the worksheet and being extracted as designated in the <Sheet> element corresponds to which position of the worksheet. In line 5, the attribute assignments “property=‘name’ templateCol=‘2’ templateRow=‘3’” in the <Cell> element designate that the value of the “name” attribute of the model element corresponding to the worksheet corresponds to the position in row 3 column 2 of the Excel worksheet.

The <Table> element (in lines 6 to 7) designates the manner of extraction of the model element corresponding to each row of the table in the worksheet from the model element being extracted as designated in the <Sheet> element and corresponding to the worksheet. The table in the worksheet is a portion of the worksheet in which cells, row headers, and column headers are arranged. In lines 6 and 7, the attribute assignment “property=‘ownedAttribute’ ” in the <Table> element designates that each of zero or more model elements referred to by the “ownedAttribute” attribute of the model element corresponding to the worksheet corresponds to a row in the table in the worksheet, and the attribute assignment “propertyKind=‘Property’ ” in the <Table> element designates that the type of the model element added to the modeling-information set 111 by addition of a row is “Property”. In addition, the attribute assignments “templateCol=‘1’ templateRow=‘6’” in the <Table> element designate that the table should start from row 6 column 1 of the worksheet.

The <Column> elements (in lines 8 to 14) designate what attribute value of the model element being extracted as designated in the <Table> element and corresponding to a row in the table corresponds to which column. The <Column> element in line 8 is the first child element of the <Table> element, and corresponds to the starting column of the table (i.e., the column designated by the “templateCol” attribute in the <Table> element). In line 8, the attribute assignment “property=‘name’ ” in the first <Column> element designates that the first column in the table corresponds to the “name” attribute. In addition, like line 8, the second to seventh <Column> elements in lines 9 to 14 respectively designate the attributes corresponding to the second to seventh columns in the table.

In the construction described above, data can be converted between the modeling-information sets 111, 112, 113, . . . and the design-data tables 121, 122, 123, . . . . The data conversion is performed in the case of synchronization of the design-data tables 121, 122, 123, . . . with the modeling-information sets 111, 112, 113, . . . , or in the case of synchronization of the modeling-information sets 111, 112, 113, . . . with the design-data tables 121, 122, 123 . . . . Hereinbelow, the processing performed by the data conversion unit 150 in each of the above cases is explained.

According to the first embodiment, books are produced in correspondence with model elements referred to by a predetermined attribute of the designated starting model element in the modeling-information sets 111, 112, 113 . . . . (Hereinafter, a model element corresponding to a book is referred to as a book-corresponding element.) In addition, one or more worksheets in each book are produced in correspondence with one or more model elements referred to by a predetermined attribute of each book-corresponding element. (Hereinafter, a model element corresponding to a worksheet is referred to as a sheet-corresponding element.) Further, each of one or more model elements referred to by a predetermined attribute of each worksheet is associated with a row in the table. (Hereinafter, a model element associated with a row is referred to as a row-corresponding element.)

### 2.6 Synchronization of Design-data Table with Modeling Information

Hereinbelow, an outline of processing for synchronizing the design-data tables 121, 122, 123, . . . with the modeling-information set 111 is explained. The synchronization is realized by newly producing a design-data table 121 on the basis of the modeling-information set 111, or by reflecting in an existing design-data table 121 a change made in the modeling-information set 111.

First, details of processing for newly producing a design-data table 121 on the basis of the modeling-information set 111, the table template 141, and the mapping definition 131 illustrated in FIGS. 4 to 6 are explained below.

The user designates, by manual input into the data conversion unit 150, the model element 111a having the name “m1” in the modeling-information set 111 (illustrated in FIG. 4), the table template 141 (illustrated in FIG. 5), the mapping definition 131 (illustrated in FIG. 6), and an empty directory as a destination of the design-data table 121. Subsequently, the user instructs the data conversion unit 150 to synchronize the design-data table with the modeling information.

Then, the table synchronization unit 151 in the data conversion unit 150 extracts, as elements corresponding to books, the model elements 111b and 111c having the names “p1” and “p2” referred to by the “nestedPackage” attribute of the model element 111a (having the name “m1”), in accordance with the descriptions in the <Book> element in the mapping definition 131. Subsequently, the table synchronization unit 151 produces books “p1.xls” and “p2.xls” in accordance with the description in the <FileName> element. In the following explanations, only the operations corresponding to the book “p1.xls” are indicated as an example.

In addition, the table synchronization unit 151 extracts, as elements corresponding to worksheets, the model elements 111d and 111e having the names “c1” and “c2” and being referred to by the “ownedMember” attribute of the model element 111b having the name “p1” and corresponding to the book “p1.xls”, in accordance with the descriptions in the <Sheet> element in the mapping definition 131. Next, the table synchronization unit 151 produces two worksheets having the sheet names “c1” and “c2” in the book “p1.xls” in accordance with the descriptions in the <SheetName> element. Specifically, the worksheets having the sheet names “c1” and “c2” can be produced by copying the worksheet having the sheet name “attr_list” and being contained in the table template 141.

Further, the table synchronization unit 151 extracts, as elements corresponding to rows in the table, the model elements 111g and 111h having the names “a11” and “a12” and being referred to by the “ownedAttribute” attribute of the model element 111d having the name “c1” and corresponding to the worksheet having the sheet name “c1”, in accordance with the descriptions in the <Table> element in the mapping definition 131. Then, the table synchronization unit 151 sets the values of the attributes of the model element 111g having the name “a11” in row 6 columns 1 to 7 in accordance with the descriptions in the <Column> elements in the mapping definition 131. For example, the table synchronization unit 151 sets the value of the “name” attribute in row 6 column 1 (as the starting position). Similarly, the table synchronization unit 151 also sets the values of the attributes of the model element 111h having the name “a12” in row 7 columns 1 to 7 in accordance with the descriptions in the <Column> elements in the mapping definition 131.

As explained above, the design-data table 121 corresponding to the model element 111b having the name “p1” is produced. Further, a design-data table corresponding to the model element 111c having the name “p2” can also be produced in a similar manner to the design-data table corresponding to the model element 111b having the name “p1”.

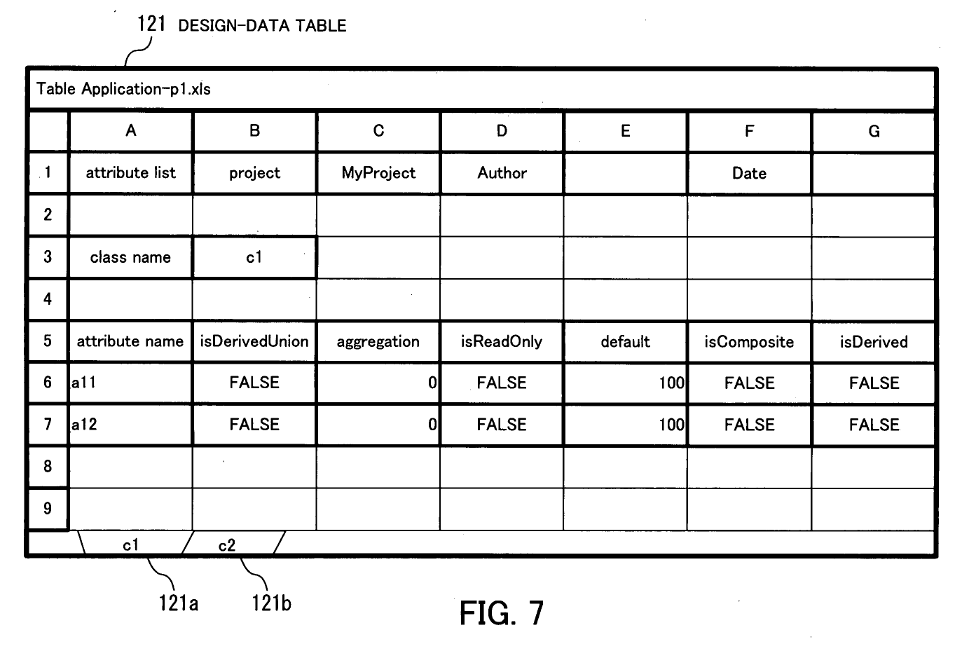

FIG. 7 is a diagram illustrating a displayed design-data table. The design-data table 121 illustrated in FIG. 7 is produced by using the model element 111b having the name “p1” as a book-corresponding element. The design-data table 121 has tabs 121a and 121b each corresponding to a worksheet. The tab 121a corresponds to the worksheet produced by designating the model element 111d having the name “c1” as a sheet-corresponding element, and the tab 121b corresponds to the worksheet produced by designating the model element 111e having the name “c2” as a sheet-corresponding element. One of the worksheets corresponding to one of the tabs 121a and 121b which is manually selected by the user is displayed on the screen. In the example illustrated in FIG. 7, the tab 121a is selected.

In the displayed worksheet, the information set in the model elements 111g and 111h referred to by the “ownedMember” attribute of the model element 111d is set in rows 6 and 7, respectively.

Although not displayed on the screen, the book storing the design-data table 121, the worksheets, and the rows (under row 5) of the tables in the worksheets each have a property, in which an identifier (ID) of the corresponding model element is set. Therefore, each model element in the modeling information can be uniquely identified by the identifier.

Changes made in the modeling-information set 111 can be reflected in the design-data table 121 (which is produced as above) by instructing the data conversion unit 150 to synchronize the design-data table 121 with the modeling-information set 111.

Specifically, in order to reflect in an existing design-data table 121 a change in the modeling-information set 111, the user designates, by manual input into the data conversion unit 150, the model element 111a having the name “m1” in the modeling-information set 111 (illustrated in FIG. 4), the table template 141, the mapping definition 131, and a directory containing the design-data table 121 as a destination of the design-data table, and instructs the data conversion unit 150 to synchronize the design-data table with the modeling-information set.

Then, the table synchronization unit 151 in the data conversion unit 150 extracts model elements assumed to correspond to the constituents of the design-data table 121 (i.e., the books, the worksheets, and the rows in tables) in accordance with the mapping definition 131, compares the structure of the current design-data table contained in the directory with the extracted model elements, and reflects in the design-data table the difference between the structure of the current design-data table and the extracted model elements. Specifically, the table synchronization unit 151 checks for correspondence between one or more model elements extracted from the modeling information and assumed to correspond to books and one or more books existing in the directory designated as the destination, newly produces a book which the directory lacks, and deletes an unnecessary book. Similar operations are performed for the subordinate structures.

That is, the table synchronization unit 151 checks for correspondence between one or more extracted model elements assumed to correspond to one or more worksheets in each book of the design-data table 121 and one or more worksheets contained in the book corresponding to the parent of the one or more extracted model elements, and corrects excess or deficiency in the one or more worksheets in the book. In addition, the table synchronization unit 151 checks for correspondence between one or more extracted model elements assumed to correspond to rows in the table in each worksheet in the design-data table 121 and one or more rows in the worksheet corresponding to the parent of the extracted model elements, and corrects excess or deficiency in the rows in the worksheet. At the same time, the table synchronization unit 151 transcribes attribute values from model elements into the corresponding constituents of the design-data table in accordance with the mapping definition.

Thus, changes in the modeling information can be reflected in existing design-data tables. In addition, both of the processing for newly producing a design-data table and the processing for reflecting in an existing design-data table changes in the modeling-information set 111 can be realized by a common processing sequence for synchronization of the design-data table with the modeling-information set 111.

Next, details of the sequence of processing for synchronizing a design-data table with modeling information by use of the functions illustrated in FIG. 3 are explained below by using the information illustrated in FIGS. 4 to 6.

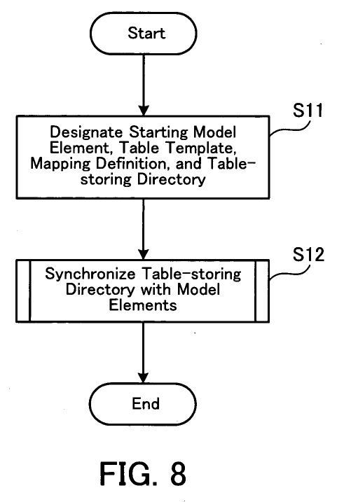

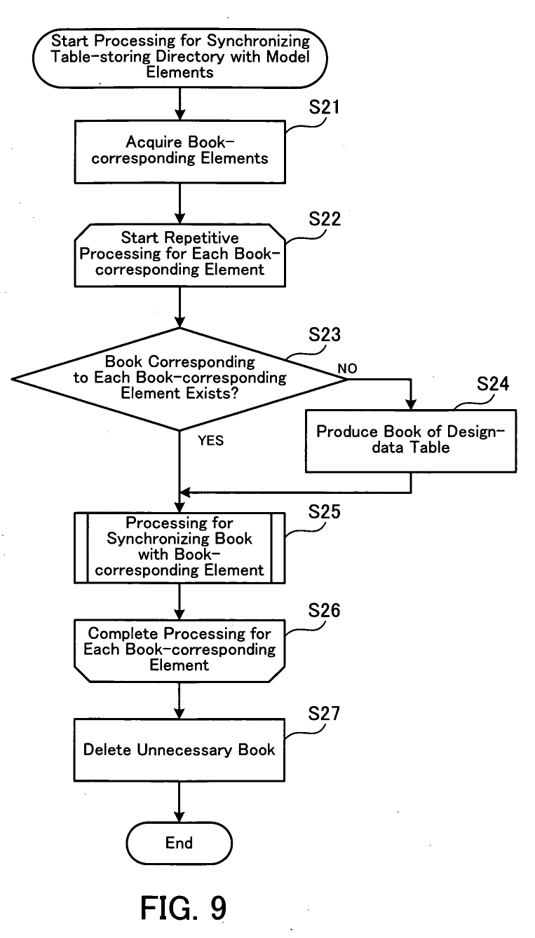

FIG. 8 is a flow diagram indicating processing for reflecting modeling information in a design-data table. The processing illustrated in FIG. 8 is explained below step by step.

<Step S11> The table synchronization unit 151 receives information for designating a starting model element, a table template, a mapping definition, and a table-storing directory, where the information is manually inputted into the system-data-architecture management system by the user. In this explanation, it is assumed that the user designates, by the manual input, the table-storing directory which stores the model element 111a in the modeling-information set 111 (illustrated in FIG. 4), the table template 141, the mapping definition 131, and the stable-storing directory containing the design-data tables 121, 122, 123 . . . .

<Step S12> The table synchronization unit 151 executes processing for synchronizing the table-storing directory with model elements. Details of the processing in step S12 is explained below with reference to FIG. 9.

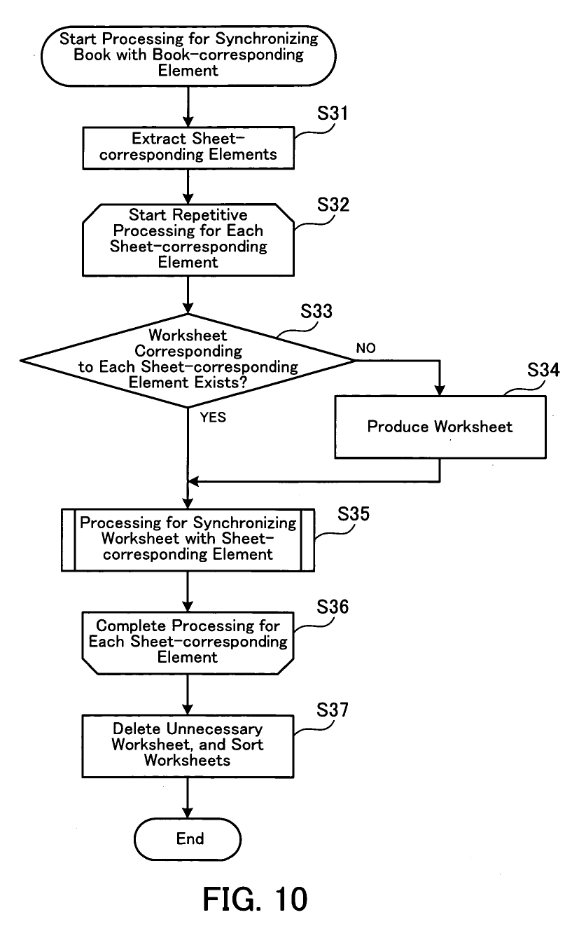

FIG. 9 is a flow diagram indicating processing for synchronizing a table-storing directory with model elements. The processing illustrated in FIG. 9 is explained below step by step.

<Step S21> The table synchronization unit 151 acquires the model elements 111b and 111c referred to by the “nestedPackage” attribute of the designated model element 111a, where the “nestedPackage” attribute is designated by the “property” attribute in the <Book> element in the mapping definition 131. At this time, the model elements 111b and 111c are the book-corresponding elements.

<Step S22> The table synchronization unit 151 starts the processing in steps S23 to S25 for each of the book-corresponding elements acquired in step S21.

<Step S23> The table synchronization unit 151 determines whether or not a book corresponding to each book-corresponding element exists. Specifically, the table synchronization unit 151 determines whether or not the table-storing directory contains a book to which the identifier (ID) of each book-corresponding element is set as a property. When yes is determined, the operation goes to step S25. When no is determined, the operation goes to step S24.

<Step. S24> The table synchronization unit 151 produces a book corresponding to each of one or more of the book-corresponding elements in the table-storing directory. Specifically, the table synchronization unit 151 acquires from the book-corresponding element a character string of the attribute designated by the “property” attribute in the <FileName> element in the mapping definition, and produces a book having the character string as a file name. When the “property” attribute indicated in the <FileName> element is “name”, the character string indicates the name of the book-corresponding element. When the table synchronization unit 151 produces a book corresponding to each of one or more of the book-corresponding elements as above, the table synchronization unit 151 sets the identifier (ID) of the corresponding book-corresponding element as the property of the book.

<Step S25> The table synchronization unit 151 executes the processing for synchronizing the book with the book-corresponding element. Details of the processing in step S25 are explained later with reference to FIG. 10.

<Step S26> When the processing in steps S23 to S25 is completed for all the book-corresponding elements acquired in step S21, the operation goes to step S27.

<Step S27> The table synchronization unit 151 deletes one or more unnecessary books. Specifically, the table synchronization unit 151 deletes each of the books existing in the table-storing directory which have an identifier (ID) of a book-corresponding element as a property and does not correspond to any of the book-corresponding elements acquired in step S21.

As described above, it is possible to produce one or more books corresponding to one or more book-corresponding elements, and delete one or more unnecessary books.

Next, the processing for synchronizing a book with a book-corresponding element is explained below.

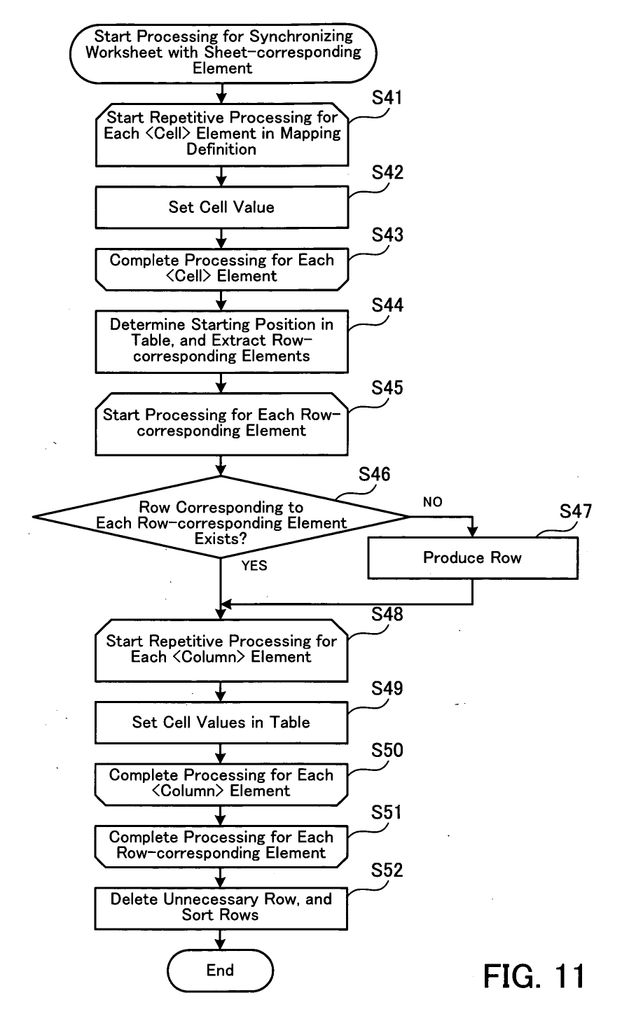

FIG. 10 is a flow diagram indicating processing for synchronizing a book with a book-corresponding element. The processing illustrated in FIG. 10 is explained below step by step.

<Step S31> The table synchronization unit 151 acquires one or more sheet-corresponding elements referred to by the book-corresponding element. Specifically, the table synchronization unit 151 acquires from the modeling-information set 111 a set of model elements referred to by the book-corresponding element by using the attribute designated by the “property” attribute in the <Sheet> element in the mapping definition 131. At this time, the acquired model elements are the sheet-corresponding elements.

<Step S32> The table synchronization unit 151 starts the processing in steps S33 to S35 for each of the acquired sheet-corresponding elements.

<Step S33> The table synchronization unit 151 determines whether or not a worksheet corresponding to each of the acquired sheet-corresponding elements exists. Specifically, the table synchronization unit 151 determines whether or not the book contains a worksheet having the identifier (ID) of each sheet-corresponding element as a property. When yes is determined, the operation goes to step S35. When no is determined, the operation goes to step S34.

<Step S34> The table synchronization unit 151 produces in the book a worksheet corresponding to each of one or more of the acquired sheet-corresponding elements. Specifically, the table synchronization unit 151 copies into the book in the design-data table 121 one of the worksheets in the table template 141 which has as the sheet name the character string designated by the “templateSheetName” attribute in the mapping definition.

<Step S35> The table synchronization unit 151 executes the processing for synchronizing the worksheet with the acquired sheet-corresponding element. Details of the processing in step S35 are explained later with reference to FIG. 11.

<Step S36> When the processing in steps S33 to S35 is completed for all the sheet-corresponding elements acquired in step S31, the operation goes to step S37.

<Step S37> The table synchronization unit 151 deletes one or more unnecessary worksheets from the book. Specifically, the table synchronization unit 151 deletes each of the worksheets existing in the book which has an identifier (ID) of a sheet-corresponding element as a property and does not correspond to any of the sheet-corresponding elements acquired in step S31. In addition, the table synchronization unit 151 sorts the worksheets into the order of the acquired sheet-corresponding elements, so that the worksheet produced in step S34 is moved to a position in accordance with the order of the acquired sheet-corresponding elements.

As described above, it is possible to perform processing for synchronizing a book with a book-corresponding element.

Next, the processing for synchronizing a worksheet with a sheet-corresponding element is explained below.

FIG. 11 is a flow diagram indicating processing for synchronizing a worksheet with a sheet-corresponding element. The processing illustrated in FIG. 11 is explained below step by step.

<Step S41> The table synchronization unit 151 starts the processing in step S42 for each <Cell> element in the mapping definition 131.

<Step S42> The table synchronization unit 151 sets a cell value in the worksheet. Specifically, the table synchronization unit 151 sets a character string designated by the “property” attribute in each <Cell> element, in the cell in the column and row respectively designated by the attributes “templateCol” and “templateRow” in the <Cell> element.

<Step S43> When the processing in step S42 is completed for all the <Cell> elements, the operation goes to step S44.

<Step S44> The table synchronization unit 151 determines the starting position in the table, and extracts one or more row-corresponding elements. Specifically, the table synchronization unit 151 determines the cell in the column and row respectively designated by the attributess “templateCol” and “templateRow” in the <Table> element to be the starting position in the table. In addition, the table synchronization unit 151 acquires from the modeling-information set 111 a set of model elements referred to by the sheet-corresponding element in the modeling-information set 111 by using the attribute designated by the “property” attribute in the <Table> element. At this time, the acquired model elements are the row-corresponding elements.

<Step S45> The table synchronization unit 151 starts the processing in steps S46 to S51 for each of the row-corresponding elements extracted in step S44.

<Step S46> The table synchronization unit 151 determines whether or not a row corresponding to the row-corresponding element exists. Specifically, the table synchronization unit 151 determines whether or not the table in the current worksheet has a row having the identifier (ID) of the row-corresponding element as a property. When yes is determined, the operation goes to step S48. When no is determined, the operation goes to step S47.

<Step S47> The table synchronization unit 151 produces a row corresponding to the row-corresponding element. Specifically, the table synchronization unit 151 adds a row to the table (for example, as the last row in the table) in the worksheet in the design-data table 121, and sets the identifier (ID) of the row-corresponding element as a property of the row.

<Step S48> The table synchronization unit 151 starts the processing in step S49 for each of the <Column> elements in the mapping definition.

<Step S49> The table synchronization unit 151 sets a cell value in the table. Specifically, the table synchronization unit 151 determines each cell by a row corresponding to the row-corresponding element and a column corresponding to the <Column> element to be executed. The columns corresponding to the <Column> elements are arrayed in the order of the descriptions in the <Column> elements in the mapping definition 131 from the first column of the table. The table synchronization unit 151 sets in the determined cell a character string designated by the “property” attribute in the <Column> element to be executed.

<Step S50> When the processing in step S49 is completed for all the <Column> elements, the operation goes to step S51.

<Step S51> When the processing in steps S46 to S50 is completed for all the row-corresponding elements, the operation goes to step S52.

<Step S52> The table synchronization unit 151 deletes one or more unnecessary rows from the table in the worksheet. Specifically, the table synchronization unit 151 deletes each of the rows existing in the worksheet which has an identifier (ID) of a row-corresponding element as a property and does not correspond to any of the row-corresponding elements acquired in step S44. Thereafter, the table synchronization unit 151 sorts the rows into the order of the extracted row-corresponding elements.

As described above, it is possible to synchronize the design-data tables 121, 122, 123, . . . with the modeling-information sets 111, 112, 113, . . . . In the synchronization, when a necessary design-data table does not exist, the design-data table is newly produced. When the necessary design-data table exists, the contents of the design-data tables 121, 122, 123, . . . are updated according to the modeling-information sets 111, 112, 113, . . . .

### 2.7 Synchronization of Modeling Information with Design-data Table

Hereinbelow, an outline of processing for synchronizing the modeling-information set 111 with the design-data tables is explained. The synchronization is realized by newly producing one or more model elements on the basis of the design-data tables 121, 122, 123, . . . , or by reflecting in the modeling-information set 111 a change made in existing the design-data tables 121, 122, 123, . . . .

First, details of processing for newly producing a modeling-information set 111 in accordance with the mapping definition 131 indicated in FIG. 6 and the design-data tables 121 and 122 (having the file names “p1.xls” and “p2.xls”) respectively corresponding to the model elements 111b and 111c are explained below. The contents of the design-data table 121 are as illustrated in FIG. 7. In the following explanation, it is assumed that the modeling-information set 111 initially contains only the model element 111a, and a process for producing the other model elements as illustrated in FIG. 4 in the modeling-information set 111 is described.

The user designates, by manual input into the data conversion unit 150, a directory containing (the book of) the design-data table 121, the mapping definition 131, and an empty model element in the modeling-information set 111 as a destination of model elements. The empty model element is a model element which does not have another model element referred to. In this case, the model element 111a is initially an empty model element. Subsequently, the user instructs the data conversion unit 150 to synchronize the modeling information with the design-data tables.

Then, the model synchronization unit 152 in the data conversion unit 150 produces the model elements 111b and 111c (of the “Package” type) corresponding to the books contained in the designated directory, in accordance with the descriptions in the <Book> element in the mapping definition 131. Hereinafter, the model elements of the “Package” type may be referred to as the “Package” elements. In addition, the model synchronization unit 152 adds the produced model elements 111b and 111c to a set of model elements referred to by the “nestedPackage” attribute of the designated model element 111a, and sets the file names (excluding the extension) of the books as the values of the “name” attribute of the “Package” elements (the model elements 111b and 111c).

Further, the model synchronization unit 152 produces the model elements 111d to 111f (of the “Class” type) corresponding to the worksheets in the books, in accordance with the descriptions in the <Book> element in the mapping definition 131. Hereinafter, the model elements of the “Class” type may be referred to as the “Class” elements. Subsequently, the model synchronization unit 152 adds the produced model elements 111d to 111f to a set of model elements referred to by the “ownedMember” attribute of the model elements 111b and 111c (i.e., the “Package” elements) corresponding to the books. In addition, the model synchronization unit 152 sets the values in row 3 column 2 of the worksheets corresponding to the produced model elements 111d to 111f (i.e., the “Class” elements produced as above), as the values of the “name” attribute of the model elements 111d to 111f, in accordance with the descriptions in the <Cell> element in the mapping definition 131.

Furthermore, the model synchronization unit 152 produces the model elements 111g to 111k (of the “Property” type) corresponding to the respective rows in the table in the worksheets in accordance with the descriptions in the <Table> element in the mapping definition 131. Subsequently, the model synchronization unit 152 adds the produced model elements 111g to 111k to a set of model elements referred to by the “ownedAttribute” attribute of the model elements 111d and 111f (i.e., the “Class” elements) corresponding to the worksheets. Hereinafter, the model elements referred to (looked up) by the “ownedAttribute” attribute may be referred to as the “ownedAttribute” elements. In addition, the model synchronization unit 152 sets the values in column 1 in the rows corresponding to the “ownedAttribute” elements (i.e., the model elements 111g to 111k) as the values of the “name” attribute of the “ownedAttribute” elements in accordance with the descriptions in the first <Column> element in the mapping definition 131. Then, the model synchronization unit 152 performs similar processing for each of the other <Column> elements in the mapping definition 131.

As described above, it is possible to produce the modeling information corresponding to the design-data tables. In addition, in order to facilitate comparison between the constituents with the model elements in the modeling-information set 111, during the above processing, an identifier (ID) for uniquely identifying each of the produced model elements is newly set to the corresponding one of the constituents (the books, the worksheets, and the rows in the tables) of the design-data tables 121 and 122 acquired by the model synchronization unit 152, and the identifiers (IDs) of the other model elements in the modeling-information set 111 are maintained in the corresponding constituents of the design-data tables 121 and 122.

Next, the processing for reflecting in existing model information changes in the design-data tables 121 and 122 is explained below. In this processing, first, the user designates, by manual input into the data conversion unit 150, a directory containing the design-data tables (books), the mapping definition 131, and the model element 111a corresponding to the (table-storing) directory as a destination of model elements, and instructs the data conversion unit 150 to synchronize the modeling information with the design-data tables.

Then, the model synchronization unit 152 in the data conversion unit 150 extracts model elements assumed to correspond to the constituents of the design-data tables 121 and 122 (i.e., the books, the worksheets, and the rows in tables) in accordance with the mapping definition 131, compares the extracted model elements with the structures of the current design-data tables contained in the directory, and reflects in the modeling information the difference between the extracted model elements and the structures of the current design-data tables. That is, the model synchronization unit 152 compares the modeling-information set 111 with the design-data tables 121 and 122, and obtains the difference between the modeling-information set 111 and the design-data tables 121 and 122 in a similar manner to the processing for synchronizing the design-data tables with the modeling information, and reflects the difference in the modeling-information set 111. In the processing for reflecting the difference, processing for production of a new model element is performed in a similar manner to the processing for production of the new modeling-information set 111.

As described above, changes in the design-data tables can be reflected in existing modeling information. In addition, both of the processing for newly producing a modeling-information set 111 and the processing for reflecting in an existing modeling-information set 111 changes in the design-data tables can be realized by a common processing sequence for synchronization of modeling information with design-data tables.

Next, details of the sequence of processing for synchronizing the modeling information with design-data tables are explained below.

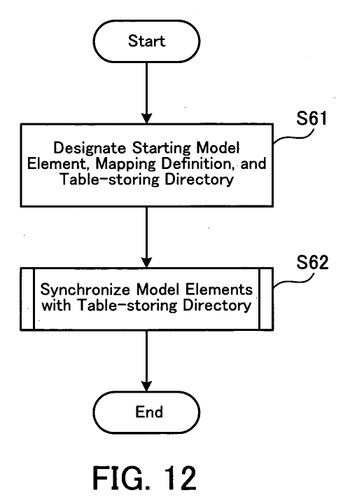

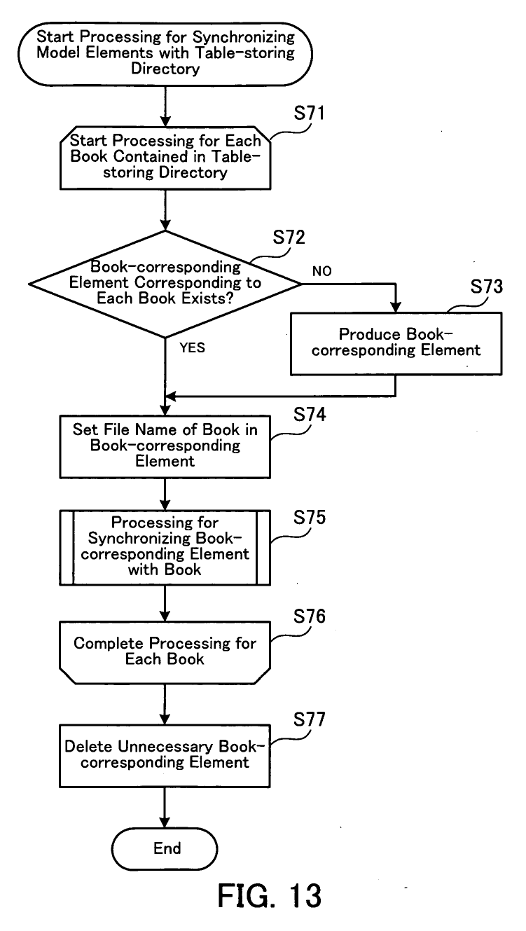

FIG. 12 is a flow diagram indicating processing for reflecting the contents of design-data tables in the modeling information. The processing illustrated in FIG. 12 is explained below step by step.

<Step S61> The model synchronization unit 152 receives information for designating a starting model element, a mapping definition, and a table-storing directory, where the information is manually inputted into the system-data-architecture management system by the user. In this explanation, it is assumed that the user designates the model element 111a in the modeling-information set 111 as shown in FIG. 3 (illustrated in FIG. 4), the mapping definition 131, and the table-storing directory storing the design-data tables 121, 122, 123 . . .

<Step S62> The model synchronization unit 152 executes processing for synchronizing the model elements with the table-storing directory. Details of the processing in step S62 is explained below with reference to FIG. 13.

FIG. 13 is a flow diagram indicating processing for synchronizing the model elements with the table-storing directory. The processing illustrated in FIG. 13 is explained below step by step.

<Step S71> The model synchronization unit 152 performs processing in steps S72 to S75 for each book contained in the table-storing directory.

<Step S72> The model synchronization unit 152 determines whether or not a book-corresponding element corresponding to the book exists. Specifically, the model synchronization unit 152 checks whether or not the following conditions (i) and (ii) are satisfied.

(i) The identifier (ID) of the book-corresponding element is set as a property of the book, and the model element having the identifier (ID) is included in the modeling-information set 111.

(ii) The model element corresponding to the identifier (ID) is referred to by the designated starting model element by using the attribute designated by the “property” attribute in the <Book> element in the mapping definition 131.

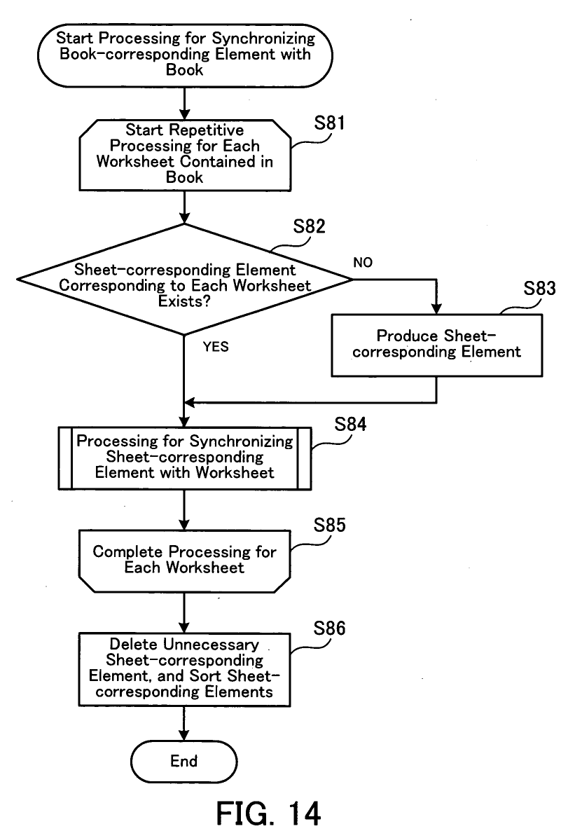

When the model synchronization unit 152 confirms that the above conditions (i) and (ii) are satisfied, the model synchronization unit 152 determines that the model element corresponding to the identifier (ID) of the book is the book-corresponding element. When a book-corresponding element corresponding to the book exists, the operation goes to step S74. When a book-corresponding element corresponding to the book does not exist, the operation goes to step S73.

<Step S73> The model synchronization unit 152 produces in the modeling-information set 111 a book-corresponding element corresponding to the book. Specifically, the model synchronization unit 152 produces a model element which is referred to by the starting model element by using the attribute designated by the “property” attribute in the <Book> element in the mapping definition 131, and adds the produced model element to the modeling-information set 111. The model element produced as above is the book-corresponding element corresponding to the book for which the processing in steps S72 to S75 is currently performed. The type of the added book-corresponding element is designated by the “propertyKind” attribute in the <Book> element in the mapping definition 131. When the book-corresponding element is added to the modeling-information set 111, the modeling-tool interface 162 assigns an identifier (ID) to the book-corresponding element for uniquely identifying the book-corresponding element. The model synchronization unit 152 receives from the modeling-tool interface 162 the identifier (ID) of the book-corresponding element, and sets the identifier (ID) as a property of the above book.

<Step S74> The model synchronization unit 152 sets the file name of the book to the book-corresponding element. Specifically, the model synchronization unit 152 extracts from the file name of the book the character string of the attribute designated by the “property” attribute in the <FileName> element in the mapping definition 131, and sets the extracted character string as the name of the book-corresponding element. Since the <FileName> element in the mapping definition 131 in FIG. 6 designates that “property=‘name’ ”, the character string of the file name of the book excluding the extension is set as the name of the book-corresponding element.

<Step S75> The model synchronization unit 152 executes the processing for synchronizing the book-corresponding element with the book. Details of the processing in step S75 are explained later with reference to FIG. 14.

<Step S76> When the processing in steps S72 to S75 is completed for all the book-corresponding elements acquired in step S71, the operation goes to step S77.

<Step S77> The model synchronization unit 152 deletes one or more unnecessary book-corresponding elements. Specifically, the model synchronization unit 152 deletes each of the model elements which is referred to by the starting model element by using the attribute designated by the “property” attribute in the <Book> element in the mapping definition 131 and does not correspond to any of the books contained in the table-storing directory (i.e., does not have the identifier (ID) of any of the books contained in the table-storing directory).

As described above, it is possible to produce one or more book-corresponding elements corresponding to one or more books, and delete one or more unnecessary book-corresponding elements.

Next, the processing for synchronizing a book-corresponding element with a book is explained below.

FIG. 14 is a flow diagram indicating processing for synchronizing a book-corresponding element with a book. The processing illustrated in FIG. 14 is explained below step by step.

<Step S81> The model synchronization unit 152 starts the processing in steps S82 to S84 for each of worksheets contained in the book.

<Step S82> The model synchronization unit 152 determines whether or not a sheet-corresponding element corresponding to the worksheet exists. Specifically, the model synchronization unit 152 checks whether or not the following conditions (iii) and (iv) are satisfied.

(iii) The identifier (ID) of the sheet-corresponding element is set as a property of the worksheet, and the model element having the identifier (ID) is included in the modeling-information set 111.

(iv) The model element corresponding to the identifier (ID) is referred to by the book-corresponding element by using the attribute designated by the “property” attribute in the <Sheet> element in the mapping definition 131.

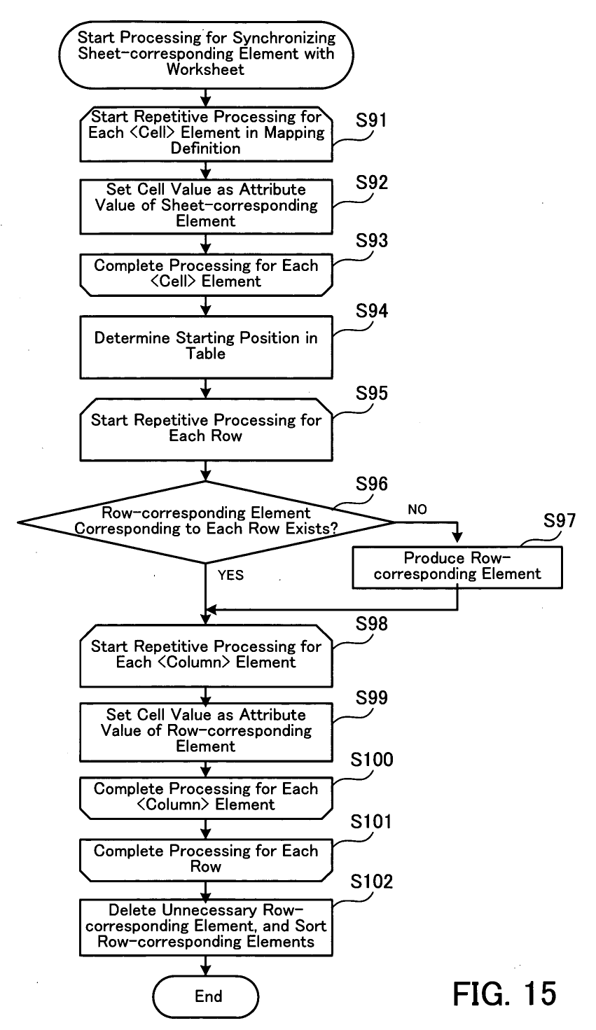

When the model synchronization unit 152 confirms that the above conditions (iii) and (iv) are satisfied, the model synchronization unit 152 determines that the model element corresponding to the identifier (ID) of the worksheet is the sheet-corresponding element. When a sheet-corresponding element corresponding to the worksheet exists, the operation goes to step S84. When a sheet-corresponding element corresponding to the worksheet does not exist, the operation goes to step S83.

<Step S83> The model synchronization unit 152 produces in the modeling-information set 111 a sheet-corresponding element corresponding to the worksheet. Specifically, the model synchronization unit 152 produces a model element referred to by the book-corresponding element by using the attribute designated by the “property” attribute in the <Sheet> element in the mapping definition 131, and adds the produced model element to the modeling-information set 111. The added model element is the sheet-corresponding element corresponding to the worksheet for which the processing in steps S82 to S84 is currently performed. The type of the added sheet-corresponding element is designated by the “propertyKind” attribute in the <Sheet> element in the mapping definition 131. When the sheet-corresponding element is added to the modeling-information set 111, the modeling-tool interface 162 assigns an identifier (ID) to the sheet-corresponding element for uniquely identifying the sheet-corresponding element. The model synchronization unit 152 receives from the modeling-tool interface 162 the identifier (ID) of the sheet-corresponding element, and sets the identifier (ID) as a property of the above worksheet.

<Step S84> The model synchronization unit 152 executes the processing for synchronizing the sheet-corresponding element with the worksheet. Details of the processing in step S84 are explained later with reference to FIG. 15.

<Step S85> When the processing in steps S82 to S84 is completed for all the worksheets contained in the book, the operation goes to step S86.

<Step S86> The model synchronization unit 152 deletes one or more unnecessary worksheets from the book. Specifically, the model synchronization unit 152 deletes each of the model elements which is referred to by the book-corresponding element by using the attribute designated by the “property” attribute in the <Sheet> element in the mapping definition 131 and does not correspond to any of the worksheets contained in the book (i.e., does not have the identifier (ID) of any of the worksheets contained in the book).

As described above, it is possible to synchronize a book-corresponding element with a book.

Next, the processing for synchronizing a sheet-corresponding element with a worksheet is explained below.

FIG. 15 is a flow diagram indicating processing for synchronizing a sheet-corresponding element with a worksheet. The processing illustrated in FIG. 15 is explained below step by step.

<Step S91> The model synchronization unit 152 starts the processing in step S92 for each <Cell> element in the mapping definition 131.

<Step S92> The model synchronization unit 152 sets a cell value as a value of an attribute of the sheet-corresponding element. Specifically, the model synchronization unit 152 determines a cell in the worksheet located in the column and row respectively designated by the attributes “templateCol” and “templateRow” in the <Cell> element, and sets the value currently set in the cell, as a value of the attribute designated by the “property” attribute of the sheet-corresponding element. In the example of FIG. 6, the <Cell> element designates that property=“name”, so that the cell value indicates the name of the sheet-corresponding element.

<Step S93> When the processing in step S92 is completed for all the <Cell> elements, the operation goes to step S94.

<Step S94> The model synchronization unit 152 determines the starting position in the table. Specifically, the model synchronization unit 152 determines the cell located in the column and row respectively designated by the attributes “templateCol” and “templateRow” in the <Table> element in the mapping definition 131 to be the starting position in the table in the worksheet.

<Step S95> The model synchronization unit 152 starts the processing in steps S96 to S100 for each of the rows in the table.

<Step S96> The model synchronization unit 152 determines whether or not a row-corresponding element corresponding to each of the rows exists. Specifically, the model synchronization unit 152 checks whether or not the following conditions (v) and (vi) are satisfied.

(v) The identifier (ID) of the row-corresponding element is set as a property of the row, and the model element having the identifier (ID) is included in the modeling-information set 111.

(vi) The model element corresponding to the identifier (ID) is referred to by the sheet-corresponding element by using an attribute designated by the “property” attribute in the <Table> element in the mapping definition 131.

When the model synchronization unit 152 confirms that the above conditions (v) and (vi) are satisfied, the model synchronization unit 152 determines that the model element corresponding to the identifier (ID) of the row is the row-corresponding element. When a row-corresponding element corresponding to the row exists, the operation goes to step S98. When a row-corresponding element corresponding to the row does not exist, the operation goes to step S97.

<Step S97> The model synchronization unit 152 produces in the modeling-information set 111 a row-corresponding element corresponding to the row. Specifically, the model synchronization unit 152 produces a model element referred to by the sheet-corresponding element on the basis of attribute designated by the “property” attribute in the <Table> element in the mapping definition 131, and adds the produced model element to the modeling-information set 111. The produced model element is the row-corresponding element corresponding to the row for which the processing in step S96 to S100 is executed. The type of the added row-corresponding element is designated by the “propertyKind” attribute in the <Table> element in the mapping definition 131. When the row-corresponding element is added to the modeling-information set 111, the modeling-tool interface 162 assigns an identifier (ID) to the row-corresponding element for uniquely identifying the row-corresponding element. The model synchronization unit 152 receives from the modeling-tool interface 162 the identifier (ID) of the row-corresponding element, and sets the identifier (ID) as a property of the row for which the processing in steps S96 to S100 is currently performed.

<Step S98> The model synchronization unit 152 starts the processing in step S99 for each of the <Column> elements in the mapping definition 131.

<Step S99> The model synchronization unit 152 sets the value currently set in the cell in the table, as attribute values of the row-corresponding element. Specifically, the model synchronization unit 152 determines each cell in the row and a column corresponding to the <Column> element to be executed. The columns corresponding to the <Column> elements are arrayed in the order of the descriptions in the <Column> elements in the mapping definition 131 from the first column of the table. The model synchronization unit 152 sets the value currently set in the determined cell, as a value of the attribute designated by the “property” attribute in the <Column> element.

<Step S100> When the processing in step S99 is completed for all the <Column> elements, the operation goes to step S101.

<Step S101> When the processing in steps S96 to S100 is completed for all the rows, the operation goes to step S102.

<Step S102> The model synchronization unit 152 deletes one or more unnecessary row-corresponding elements. Specifically, the model synchronization unit 152 deletes each of the row-corresponding elements which is referred to by the sheet-corresponding element by using the attribute designated by the “property” attribute in the <Table> element in the mapping definition 131 and does not correspond to any of the rows contained in the table (i.e., does not have the identifier (ID) of any of the rows contained in the table). Thereafter, the model synchronization unit 152 sorts the row-corresponding elements into the order of the rows.

Thus, it is possible to synchronize a sheet-corresponding element with a worksheet.

As described above, according to the first embodiment, it is possible to easily manage data used in a computer system by synchronizing the modeling information and design-data tables. That is, in the case where it is easy for the user to use the modeling information, the user handles and edits the modeling information by use of the modeling tool 161. At this time, the consistency between the modeling information and the design-data tables can be maintained by reflecting the modeling information in the design-data tables. On the other hand, in the case where it is easy for the user to handle the tabulated data items in the design-data tables, the user handles and edits the design-data tables by use of the table application 171. At this time, the consistency between the modeling information and the design-data tables can also be maintained by reflecting the contents of the design-data tables in the modeling information.

In addition, according to the first embodiment, when a row-corresponding element corresponding to a row in a design-data table is determined to exist in the modeling information in the processing for synchronization, an attribute value set in the row is additionally set in the row-corresponding element. Therefore, it is possible to maintain other attributes of the row-corresponding element which are not to be synchronized, as they are.

In the first embodiment, the rows are associated with model elements, and the columns are associated with attributes of the model elements. Alternatively, it is possible to associate the columns with model elements, and the rows with attributes of the model elements.

### 3. Second Embodiment

### 3.1 Difference from First Embodiment

The second embodiment of the present invention is explained below. In the second embodiment, design-data tables are in a matrix format in which both the rows and the columns are associated with model elements.

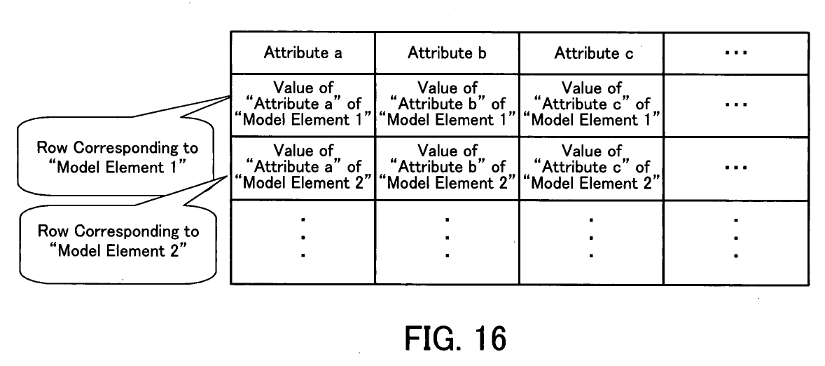

In the first embodiment, the rows are respectively associated with model elements and the columns are respectively associated with the attributes of the model elements. Hereinafter, the format of the design-data tables according to the first embodiment is referred to as the list format. FIG. 16 is a diagram illustrating a design-data table in the list format. As illustrated in FIG. 16, in design-data tables in the list format, the rows are associated with model elements, the columns are associated with attributes of the model elements, and the values of the attributes set in the respective model elements are set in the cells.

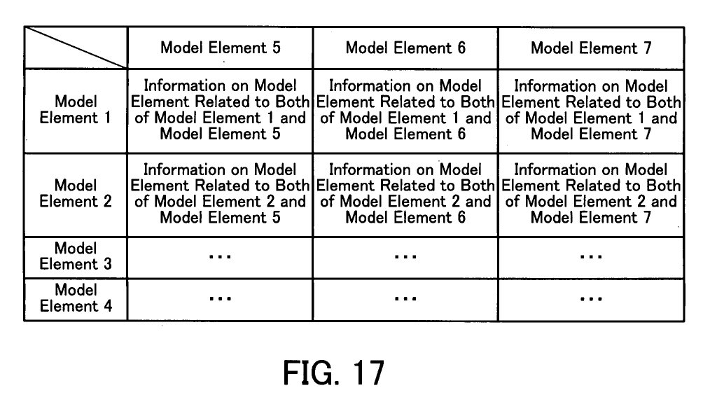

On the other hand, according to the second embodiment, the rows and columns are respectively associated with model elements, and each cell contains information on a model element related to both of the model element associated with the corresponding row and the model element associated with the corresponding column. Hereinafter, the format of the design-data tables according to the second embodiment is referred to as the matrix format. FIG. 17 is a diagram illustrating a design-data table in the matrix format. As illustrated in FIG. 17, in design-data tables having the matrix format, the rows and columns are respectively associated with model elements, and the cell at which a row and a column intersects contains information on a model element related to both of the model element associated with the row and the model element associated with the column.

Hereinbelow, the processing which is performed in the case where design-data tables are in the matrix format is explained. The functions necessary for realizing the second embodiment of the present invention are similar to the functions for the first embodiment illustrated in FIG. 3, and the second embodiment is different from the first embodiment only in the processing performed by the table synchronization unit 151 and the model synchronization unit 152. Therefore, FIG. 3 is also referred to in the following explanations on the second embodiment.

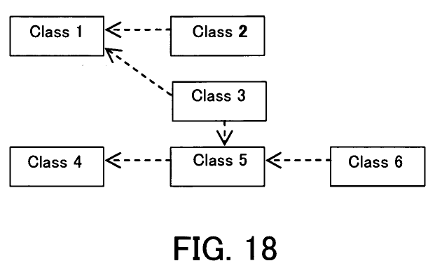

The systems in which complex dependency relationships exist between classes are examples in which design-data tables in the matrix format are useful. FIG. 18 is a diagram indicating dependency relationships between classes contained in a package. In FIG. 18, the dependency relationships are indicated by arrowed dashed lines, and the class at the starting point of each arrowed line depends on the class at the arrowhead of the arrowed line. Specifically, the depending class is influenced by changes in the depended class. For example, in FIG. 18, the classes 2 and 3 depend on the class 1.

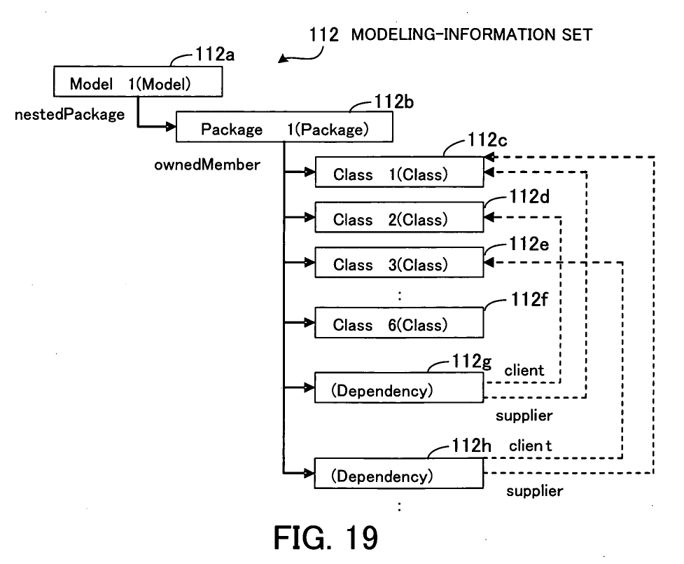

FIG. 19 is a diagram illustrating a modeling-information set 112 corresponding to the diagram of FIG. 18. In FIG. 19, the rectangles 112a to 112h represent model elements, the character string outside the parentheses in each rectangle represents the name of the corresponding model element, and the character string in the parentheses in each rectangle represents the type of the corresponding model element (a blank before the parentheses represent that there is no name). In addition, the arrowed solid lines represent owner relationships between the model elements, and the model element at the starting point of each arrowed solid line owns the model element at the arrowhead of the arrowed solid line as a value of an attribute, where the name of the attribute is indicated in the vicinity of the starting point of each arrowed solid line. Further, the arrowed dashed lines represent reference relationships between the model elements, and the model element at the starting point of each arrowed dashed line refers to the model element at the arrowhead of the arrowed dashed line as a value of an attribute, where the name of the attribute is indicated in the vicinity of the starting point of each arrowed dashed line.

The structure of a model which includes the dependency relationships illustrated in FIG. 18 is explained below with reference to FIG. 19, although some “Class” elements and “Dependency” elements are not shown in FIG. 19.

The element “Model 1” 112a of the “Model” type (i.e., the “Model” element “Model 1” 112a) owns the element “Package 1” 112b of the “Package” type (i.e., the “Package” element “Package 1” 112b) as a value of the “nestedPackage” attribute, and the “Package” element “Package 1” 112b owns six elements “Class 1” to “Class 6” 112c to 112f of the “Class” type (i.e., the “Class” elements “Class 1” to “Class 6” 112c to 112f) and five elements 112g to 112h of the “Dependency” type (i.e., the “Dependency” elements 112g to 112h) which represent the dependency relationships between the six “Class” elements “Class 1” to “Class 6” 112c to 112f. For example, the “Dependency” element 112g owns the “Class” element “Class 1” 112c as a value of the “supplier” attribute, and the “Class” element “Class 2” 112d as a value of the “client” attribute, so that the “Dependency” element 112g can refer to the “Class” element “Class 1” 112c as a value of the “supplier” attribute, and the “Class” element “Class 2” 112d as a value of the “client” attribute. The owner relationships are stronger connections than the reference relationships.

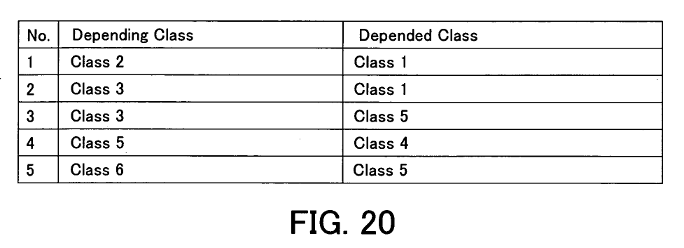

If the dependency relationships are indicated in the list format according to the first embodiment, for example, a design-data table as illustrated in FIG. 20 is produced. In the example of FIG. 20, the rows of the design-data table are respectively associated with the dependency relationships. In each column, a depending class and a depended class in the dependency relationship associated with the row are listed. Although the dependency relationships can be recognized from the list format as illustrated in FIG. 20, in some cases, the matrix format is easier to use.

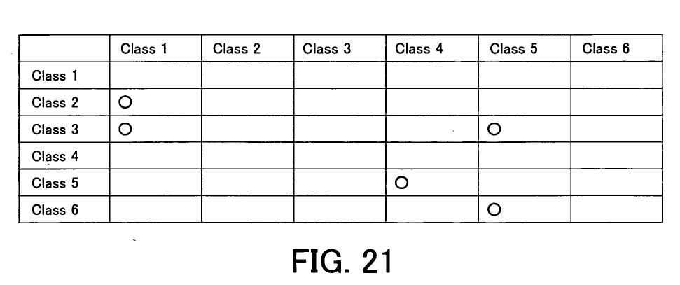

FIG. 21 is a diagram illustrating a design-data table in which dependency relationships are indicated in the matrix format. In the example of FIG. 21, the model element corresponding to each class is associated with both of a row and a column, and each cell at which a row and a column intersect indicates the presence or absence of a dependency relationship between the class associated with the row and the class associated with the column. When a dependency relationship exists, a flag indicating the presence of a dependency relationship is set in the cell. In the example of FIG. 21, a blank circle indicates the presence of a dependency relationship.

### 3.2 Table Template and Mapping Definition

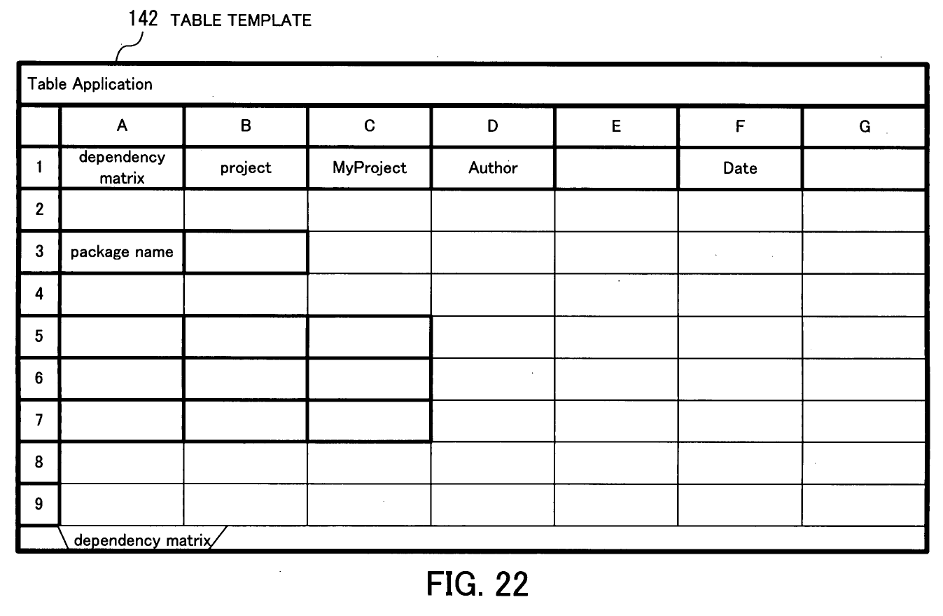

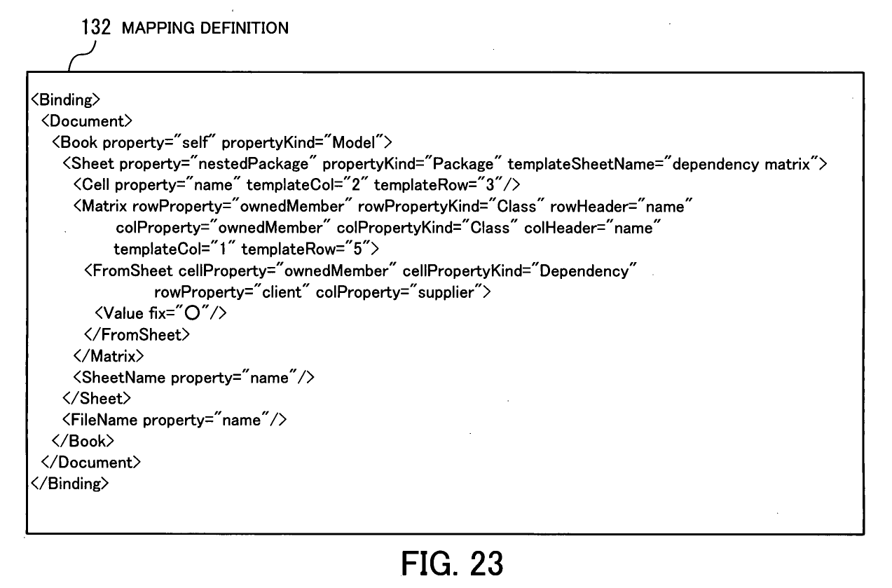

In order to produce a design-data table in the matrix format, for example, the table template as illustrated in FIG. 22 and the mapping definition as illustrated in FIG. 23 can be used.

FIG. 22 is a diagram illustrating an example of a template of a design-data table for indicating information in the matrix format. The table template 142 of FIG. 22 is different from the table template 141 of FIG. 5 in only the table portion (in which cells, row headers, and column headers are arranged). In the table template in the list format, the number of columns and the header character strings in the column headers are fixed, and the columns and the header character strings in the column headers are embedded in advance. On the other hand, in the table template in the matrix format, the column headers (as well as the row headers) are dynamically arranged (during processing for synchronization) according to a model and a mapping definition which are inputted into the system-data-architecture management system. Therefore, only a format pattern including the ruled lines of the table, hatching, and the like are embedded in advance in the table template in the matrix format.

The table portion in the table template 142 has three rows and three columns since rows and columns are arranged in the processing for synchronization under the following conditions (a) to (d).

(a) The format pattern for the second row (row 2) of the table in the table template is used for arranging rows other than the bottom row in the design-data table.

(b) The format pattern for the third row (row 3) of the table in the table template is used for arranging the bottom row in the design-data table.

(c) The format pattern for the second column (column 2) of the table in the table template is used for arranging rows other than the rightmost column in the design-data table.

(d) The format pattern for the third column (column 3) of the table in the table template is used for arranging the rightmost column in the design-data table.

Therefore, for example, when a row other than the bottom row is newly added to the table in a design-data table, the format pattern for row 2 column 1 of the table in the table template is used for producing cells for row headers, the format pattern for row 2 column 2 of the table in the table template is used for producing cells other than the cells for row headers and the cells in the bottom row, and the format pattern for row 2 column 3 of the table in the table template is used for producing cells in the rightmost column.

FIG. 23 is a diagram illustrating a mapping definition for producing a design-data table in the matrix format. Although the mapping definition 132 for the matrix format indicated in FIG. 23 is similar to the mapping definition 131 for the list format indicated in FIG. 6, the <Matrix> element, instead of the <Table> element, is used in the mapping definition 132. Therefore, only the <Matrix> element including the descendent elements of the <Matrix> element is explained below. The other elements in the mapping definition 132 have similar meanings to the mapping definition 131.

The <Matrix> element designates a manner of extracting a model element corresponding to each row (i.e., a row-corresponding element), a manner of acquiring a character string for each row header, a manner of extracting a model element corresponding to each column (hereinafter referred to as a column-corresponding element), and a manner of acquiring a character string for each column header. Details of the operations described in the <Matrix> element are as follows.

The “rowProperty” attribute indicated in the <Matrix> element designates an attribute of the sheet-corresponding element, and the values of the designated attribute correspond to a set of model elements. One or more of the values of the designated attribute corresponding to the type designated by the “rowPropertyKind” attribute in the <Matrix> element are extracted as one or more row-corresponding elements, and one or more values of an attribute of the row-corresponding elements designated by the “rowHeader” attribute are used as one or more character strings for the row headers. Therefore, in the case where the mapping definition 132 of FIG. 23 is used, model elements of the “Class” type owned as values of the “ownedMember” attribute of the sheet-corresponding element (of the “Package” type) are extracted as row-corresponding elements, and the values of the “name” attribute of the row-corresponding elements are used as the character strings for the row headers.

In addition, the “colProperty” attribute indicated in the <Matrix> element designates an attribute of the sheet-corresponding element, and the values of the designated attribute correspond to a set of model elements. One or more of the values of the designated attribute corresponding to the type designated by the “colPropertyKind” attribute in the <Matrix> element are extracted as one or more column-corresponding elements, and one or more values of an attribute of the column-corresponding elements designated by the “colHeader” attribute are used as one or more character strings for the column headers. Therefore, in the case where the mapping definition 132 of FIG. 23 is used, model elements of the “Class” type owned as values of the “ownedMember” attribute of the sheet-corresponding element (of the “Package” type) are extracted as column-corresponding elements, and the values of the “name” attribute of the column-corresponding elements are used as the character strings for the column headers. In the mapping definition 132, the row-corresponding elements and the column-corresponding elements are specified in an identical manner. Similarly to the mapping definition 131 for the list format, the attributes “templateCol” and “templateRow” respectively designate a row and a column of the starting position in the table in the matrix format. Hereinafter, a portion of a design-data table in which cells, row headers, and column headers are arranged in the matrix format is referred to as the matrix table.

The <FromSheet> element designates a manner of extracting a model element corresponding to each cell in the table in the matrix format and a manner of determining from a cell-corresponding element a row-corresponding element and a column-corresponding element which are related to the cell-corresponding element. Details of the operations described in the <FromSheet> element are explained below. Hereinafter, a model element corresponding to each cell in the matrix table is referred to as a cell-corresponding element.

The “cellProperty” attribute indicated in the <FromSheet> element designates an attribute of the sheet-corresponding element, and the values of the designated attribute correspond to a set of model elements. One or more of the values of the designated attribute corresponding to the type designated by the “cellPropertyKind” attribute in the <FromSheet> element are extracted as one or more cell-corresponding elements. In addition, a value of an attribute of each cell-corresponding element designated by the “rowProperty” attribute is determined to be a row-corresponding element, and a value of an attribute of each cell-corresponding element designated by the “colProperty” attribute is determined to be a column-corresponding element. Therefore, in the case where the mapping definition 132 of FIG. 23 is used, model elements of the “Dependency” type owned as values of the “ownedMember” attribute of the sheet-corresponding element (of the “Package” type) are extracted as cell-corresponding elements, where a value of the “client” attribute of each cell-corresponding element is determined to be a row-corresponding element, and a value of the “supplier” attribute of each cell-corresponding element is determined to be a column-corresponding element.

The <Value> element designates a value corresponding to each cell-corresponding element. Specifically, the value of the “fix” attribute designated in the <Value> element (indicating the symbol of a blank circle in the example of the mapping definition 132 of FIG. 23) is outputted to the cell in the row and column respectively corresponding to the row-corresponding element and the column-corresponding element which are determined by each cell-corresponding element which is extracted in accordance with the <FromSheet> element.

When a design-data table is newly produced by using the table template 142 and the mapping definition 132 described above and executing processing for synchronization of a design-data table with the modeling-information set 112 of FIG. 19, the operations for newly producing a design-data table are briefly as follows.

(1) The user designates the model element “Model 1” 112a as the starting model element in the processing for synchronization. The <Book> element in the mapping definition 132 includes the attribute assignment “property=‘self’ ”, which means that the current model element per se is the book-corresponding element. Therefore, in this case, the table synchronization unit 151 determines the model element “Model 1” 112a designated as the starting model element to be the book-corresponding element. In addition, a design-data table (book) corresponding to this book-corresponding element is produced in a table-storing directory, and the identifier (ID) of the book-corresponding element is set as a property of the book. The value “Model 1.xls” of the “name” attribute of the book-corresponding element is set as the file name of the produced book on the basis of the attribute assignment “property=‘name’ ” in the <FileName>element.

(2) In accordance with the attribute assignments “property=‘nestedPackage’ propertyKind=‘Package’” in the <Sheet> element, the model element “Package 1” of the “Package” type corresponding to a value of the “nestedPackage” attribute is extracted from the book-corresponding element “model 1”, and is determined to be a sheet-corresponding element. In addition, in accordance with the attribute assignment “templateSheetName=‘dependency matrix’ ” in the <Sheet> element, a worksheet in the table template is copied into the book, in which a worksheet having the same name as the worksheet in the table template. In addition, the identifier (ID) of the sheet-corresponding element is set as a property of the copied worksheet. The value “Package 1” of the “name” attribute of the sheet-corresponding element is set as the file name of the copied worksheet in accordance with the attribute assignment “property=‘name’ ” in the <SheetName> element in the mapping definition 132.

(3) The value of the “name” attribute of the sheet-corresponding element “Package 1” is acquired in accordance with the attribute assignment “property=‘name,’” in the <Cell> element in the mapping definition 132, and set in the cell in the third row and the second column respectively designated by the attributes “templateRow” and “templateCol” in the <Cell> element.

(4) The “Class” elements “Class 1” to “Class 6”, which are model elements of the “Class” type corresponding to values of the “ownedMember” attribute of the sheet-corresponding element “Package 1”, are extracted in accordance with the attribute assignments “rowProperty=‘ownedMember’ rowPropertyKind=‘Class’ ” in the <Matrix> element, and are determined to be row-corresponding elements. In addition, in accordance with the attribute assignment “rowHeader=‘name’ ” in the <Matrix> element, the values of the “name” attribute of the above row-corresponding elements are set in the column designated by the “templateCol” attribute (in the first column in the example of FIG. 23) in succession downward from the row following the row designated by the “templateRow” attribute (from the sixth row in the example of FIG. 23). At the same time, the identifiers (IDs) of the row-corresponding elements are respectively set as the properties of the corresponding rows.

Similarly, the “Class” elements “Class 1” to “Class 6”, which are model elements of the “Class” type corresponding to values of the “ownedMember” attribute of the sheet-corresponding element “Package 1”, are extracted in accordance with the attribute assignments “colProperty=‘ownedMember’ colPropertyKind=‘Class’ ” in the <Matrix> element, and are determined to be column-corresponding elements. In addition, in accordance with the attribute assignment “colHeader=‘name’ ” in the <Matrix> element, the values of the “name” attribute of the above column-corresponding elements are set in the row designated by the “templateRow” attribute (in the fifth row in the example of FIG. 23) in succession rightward from the column following the column designated by the “templateCol” attribute (from the second column in the example of FIG. 23). At the same time, the identifiers (IDs) of the column-corresponding elements are respectively set as the properties of the corresponding columns.

(5) The (five) model elements of the “Dependency” type corresponding to values of the “ownedMember” attribute of the sheet-corresponding element “Package 1” are extracted in accordance with the attribute assignments “cellProperty=‘ownedMember’ cellPropertyKind=‘Dependency’ ” in the <FromSheet> element, and are determined to be cell-corresponding elements. In addition, since the <FromSheet> element designates that “rowProperty=‘client’ colProperty=‘supplier’ ”, a model element referred to by each of the extracted cell-corresponding elements in accordance with the “client” attribute is determined to be a row-corresponding element corresponding to the cell-corresponding element, and a model element referred to by each of the extracted cell-corresponding elements in accordance with the “supplier” attribute is determined to be a column-corresponding element corresponding to the cell-corresponding element. Then, the table synchronization unit 151 outputs the value (indicating the blank circle) of the “fix” attribute in the <Value> element in the mapping definition 132, to the cell at which a row corresponding to the row-corresponding element and a column corresponding to the column-corresponding element intersect, where both of the row-corresponding element and the column-corresponding element correspond to each cell-corresponding element extracted as above.

### 3.3 Design-Data Table

By using the table template and the mapping definition explained above, the following design-data table is outputted.

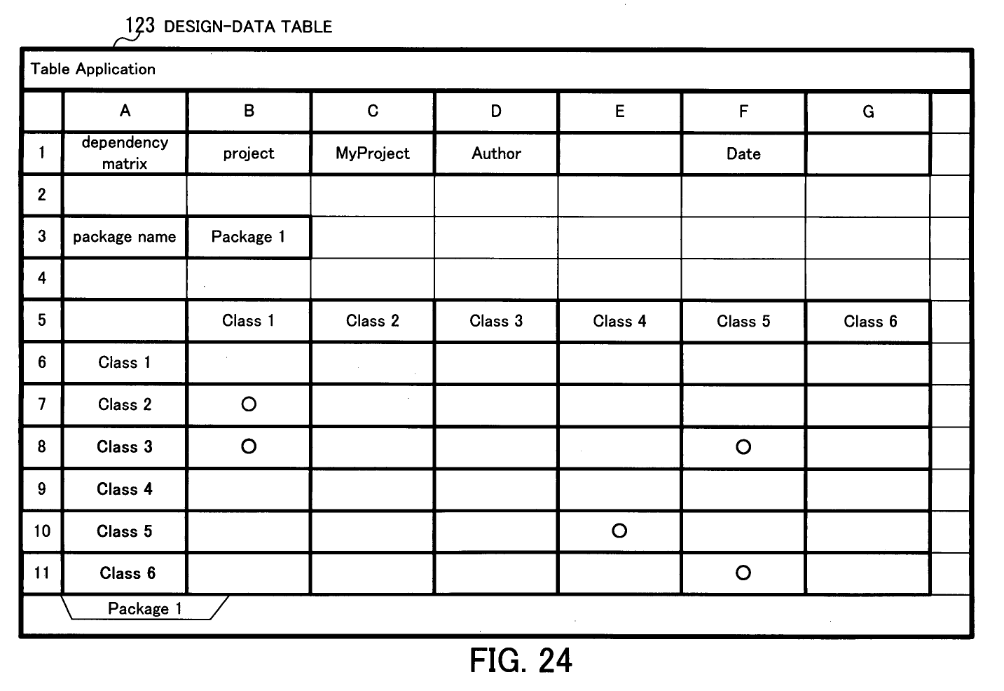

FIG. 24 is a diagram illustrating an example of a design-data table in the matrix format. In the design-data table 123 illustrated in FIG. 24, the class names are associated with the rows and the columns, and the cells are arranged in a matrix format. When a dependency relationship exists between first and second classes, a value for indicating a blank circle is set in the cell at which the row corresponding to the first class and the column corresponding to the second class intersect.

When the design-data table 123 is produced in advance by the user, and the modeling-information set 112 is not yet produced, the modeling-information set 112 can be newly produced by performing processing for synchronization of the modeling-information set 112 with the design-data table 123 by use of the mapping definition 132. The processing performed in such a case is roughly explained below.

The user designates, by manual input into the data conversion unit 150, the design-data table 123 illustrated in FIG. 24, as the starting point of the processing for synchronization. In addition, the user instructs, by manual input, the data conversion unit 150 to perform the processing for synchronization of a modeling-information set with the design-data table.

Then, the model synchronization unit 152 in the data conversion unit 150 produces a model element of the “Model” type in accordance with the “propertyKind” attribute designated in the <Book> element in the mapping definition 132, since no modeling-information set corresponding to the design-data table 123 exists at this time. In addition, since the <Book> element in the mapping definition 132 designates that “property=‘self’ ”, the model synchronization unit 152 determines the produced model element to be a book-corresponding element. Further, the model synchronization unit 152 sets the file name “Model 1” of the design-data table 123 as a value of the “name” attribute of the book-corresponding element.

Since no model element corresponding to a worksheet exists at this time, the model synchronization unit 152 produces one or more model elements of the “Package” type in accordance with the attribute assignments “property=‘nestedPackage’ propertyKind=‘Package’ ” in the <Sheet> element in the mapping definition 132, and adds the produced model elements to a set of model elements referred to by the “nestedPackage” attribute of the book-corresponding element. That is, the model synchronization unit 152 adds one or more values corresponding to the produced model elements to the values of the “nestedPackage” attribute.

The model synchronization unit 152 acquires the value “Package 1” in the cell in row 3 column 2 in accordance with the attribute assignments “templateCol=‘2’ templateRow=‘3’” in the <Cell> element in the mapping definition 132, and sets the acquired value as a value of the “name” attribute of the sheet-corresponding element.

In addition, the model synchronization unit 152 acquires row headers in the cells in the first column in succession downward from the sixth row in accordance with the attribute assignments “templateCol=‘l’ templateRow=‘5’” in the <Matrix> element in the mapping definition 132. Subsequently, the model synchronization unit 152 produces model elements of the “Class” type as a portion of a set of model elements owned by the “ownedMember” attribute of the sheet-corresponding element, in accordance with the attribute assignments “rowProperty=‘ownedMember’ rowPropertyKind=‘Class’ rowHeader=‘name’ ” in the <Matrix> element in the mapping definition 132. Further, the model synchronization unit 152 sets the values “Class1” to “Class 6” of the acquired row headers as the values of the “name” attribute of the produced model elements.

Furthermore, the model synchronization unit 152 acquires column headers in the cells in the fifth row in succession rightward from the second column in accordance with the attribute assignments “templateCol=‘1’ templateRow=‘5’” in the <Matrix> element in the mapping definition 132. Subsequently, the model synchronization unit 152 produces more model elements of the “Class” type as a portion of a set of model elements owned by the “ownedMember” attribute of the sheet-corresponding element, in accordance with the attribute assignments “colProperty=‘ownedMember’ colPropertyKind=‘Class’ colHeader=‘name’ ” in the <Matrix> element in the mapping definition 132. In addition, the model synchronization unit 152 sets the values “Class1” to “Class 6” of the acquired column headers as the values of the “name” attribute of the produced model elements. However, the model synchronization unit 152 does not doubly produce a model element of an identical type having an identical name and corresponding to an identical attribute value to another model element which is already set, where the name is an attribute value designating a character string for a header.

When one or more model elements are added, the modeling-tool interface 162 adds an identifier (ID) to each of the model elements for uniquely identifying the model element. The model synchronization unit 152 acquires the identifier (ID) of each of the model elements from the modeling-tool interface 162, and sets the acquired identifier (ID) as a property of the row or column corresponding to the model element.

The model synchronization unit 152 detects one or more cells in which the value (indicating the blank circle in the example of FIG. 23) of the “fix” attribute in the <Value> element in the mapping definition 132 is set. The model synchronization unit 152 produces, for each of the one or more cells, a set of model elements of the “Dependency” type owned by the “ownedMember” attribute of the sheet-corresponding element, in accordance with the attribute assignments “cellProperty=‘ownedMember’ cellPropertyKind=‘Dependency’ ” in the <FromSheet> element in the mapping definition 132.

The model synchronization unit 152 determines a row-corresponding element and a column-corresponding element corresponding to each of the cells in which the value of the “fix” attribute of the <Value> element is set, on the basis of the identifiers (ID) which are set as the properties of the corresponding row and column. In addition, the model synchronization unit 152 sets a row-corresponding element designated by the “client” attribute of each of the model elements of the “Dependency” type produced as above, and a column-corresponding element designated by the “supplier” attribute of each of the model elements of the “Dependency” type, in accordance with the attribute assignments “rowProperty=‘client’ colProperty=‘supplier’ ” in the <FromSheet> element in the mapping definition 132.

Hereinbelow, details of the sequence of processing for synchronizing the modeling-information set 112 and the design-data table 123 (in the matrix format) according to the second embodiment are explained below.

### 3.4 Synchronization of Design-data Table with Modeling Information

First, processing for synchronization of the design-data table 123 with the modeling-information set 112 is explained below. In this processing, only the operations for synchronizing a worksheet with a sheet-corresponding element are different from the first embodiment. That is, the operations performed in the second embodiment for reflecting modeling information in a design-data table, for synchronizing a table-storing directory with model elements, and for synchronizing a book with a book-corresponding element are respectively similar to the operations explained with reference to FIGS. 8 to 10. Therefore, only the processing for synchronizing a worksheet with a sheet-corresponding element is explained in detail below.

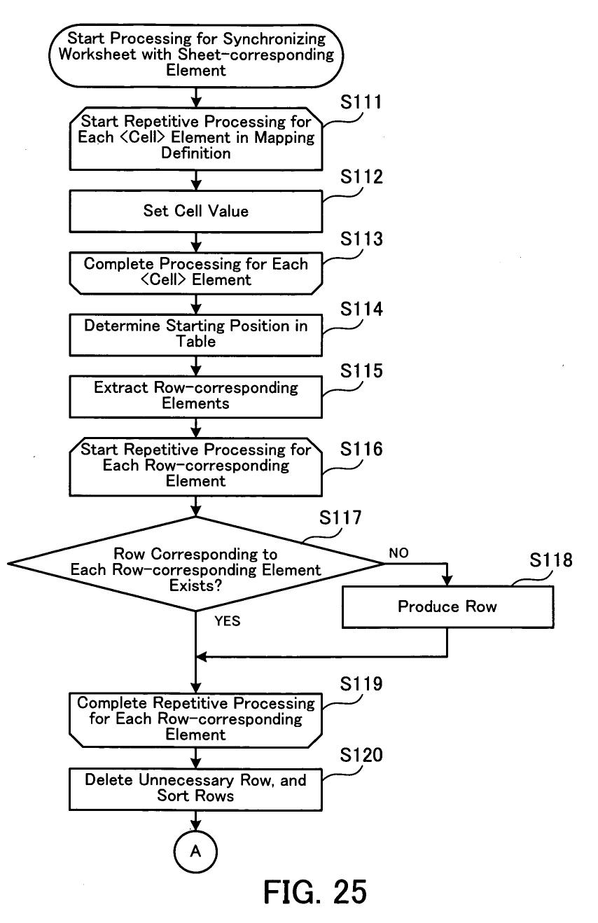

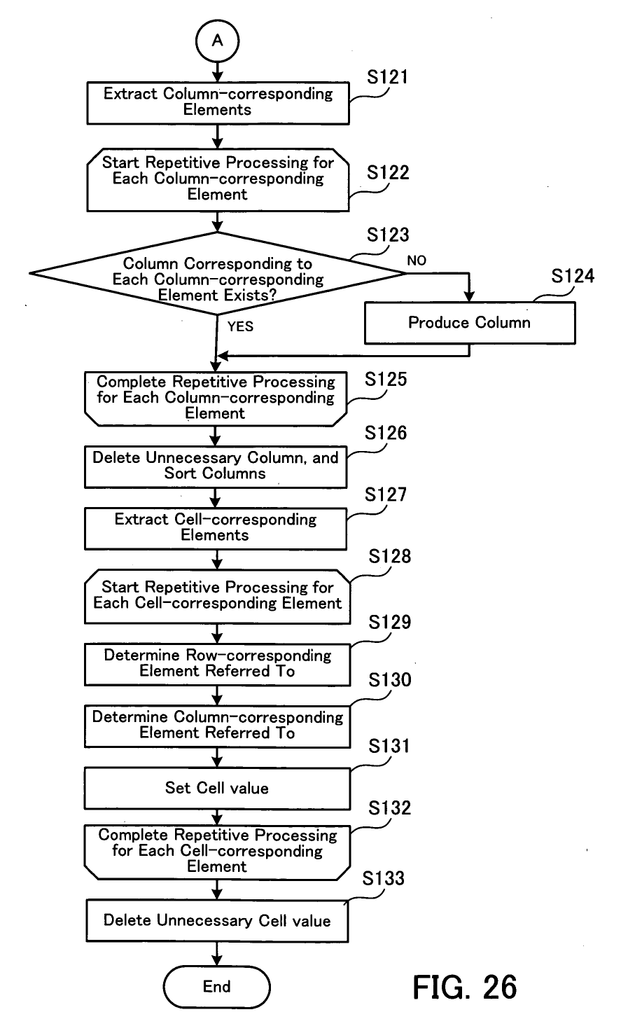

FIGS. 25 and 26 are flow diagrams indicating processing for synchronizing a worksheet with a sheet-corresponding element. The processing illustrated in FIGS. 25 and 26 is explained below step by step.

<Step S111> The table synchronization unit 151 repeatedly performs the processing in step S112 for each <Cell> element in the mapping definition 132.

<Step S112> The table synchronization unit 151 sets a cell value. Specifically, the table synchronization unit 151 sets an attribute value (character string) of the sheet-corresponding element designated by the “property” attribute in the <Cell> element, in the cell located in the row and column designated by the attributes “templateCol” and “templateRow” in the <Cell> element.

<Step S113> When the processing in step S112 is completed for all the <Cell> elements, the operation goes to step S114.

<Step S114> The table synchronization unit 151 determines the starting position in the matrix table. Specifically, the table synchronization unit 151 determines the cell in the column and row respectively designated by the attributes “templateCol” and “templateRow” in the <Matrix> element in the mapping definition 132 to be the starting position in the matrix table.

<Step S115> The table synchronization unit 151 extracts row-corresponding elements. Specifically, the table synchronization unit 151 acquires from the modeling-information set 112 a set of model elements owned by the sheet-corresponding element on the basis of the attribute designated by the “rowProperty” attribute in the <Matrix> element in the mapping definition 132. Subsequently, the table synchronization unit 151 extracts from the acquired set of model elements model elements of the type designated by the “rowPropertyKind”. The extracted model elements are the row-corresponding elements.

<Step S116> The table synchronization unit 151 starts the processing in steps S117 and S118 for each of the row-corresponding elements extracted in step S115.

<Step S117> The table synchronization unit 151 determines whether or not a row corresponding to the row-corresponding element exists. Specifically, the table synchronization unit 151 determines whether or not the current matrix table has a row having the identifier (ID) of the row-corresponding element as a property. When yes is determined, the operation goes to step S119. When no is determined, the operation goes to step S118.

<Step S118> The table synchronization unit 151 produces a row corresponding to the row-corresponding element. Specifically, the table synchronization unit 151 adds a row to the position following the last row in the matrix table in the design-data table 121. In the case where no row has been set yet, the row is added at the starting position. At this time, ruled lines for the matrix table are set again. Subsequently, the table synchronization unit 151 sets the identifier (ID) of the row-corresponding element as a property of the added row. In addition, the table synchronization unit 151 acquires from the row-corresponding element the attribute value (character string) designated by the “rowHeader” attribute in the <Matrix> element in the mapping definition 132, and sets the acquired the attribute value in the leading cell in the row (i.e., the cell in the column to which the starting position belongs) as a row header.

<Step S119> When the processing in steps S117 and S118 is completed for all the row-corresponding elements, the operation goes to step S120.

<Step S120> The table synchronization unit 151 deletes one or more unnecessary rows from the matrix table in the worksheet. Specifically, when a row existing in the worksheet has an identifier (ID) of a row-corresponding element as a property, and none of the row-corresponding elements extracted in step S115 has the identifier (ID), the table synchronization unit 151 deletes the row. Thereafter, the table synchronization unit 151 sorts the rows in the matrix table into the order of the extracted row-corresponding elements, and the operation goes to step S121 in FIG. 26.

<Step S121> The table synchronization unit 151 extracts column-corresponding elements. Specifically, the table synchronization unit 151 acquires from the modeling-information set 112 a set of model elements owned by the sheet-corresponding element on the basis of the attribute designated by the “colProperty” attribute in the <Matrix> element. Subsequently, the table synchronization unit 151 extracts from the acquired set of model elements model elements of the type designated by the “colPropertyKind”. The extracted model elements are the column-corresponding elements.

<Step S122> The table synchronization unit 151 starts the processing in steps S123 and S124 for each of the column-corresponding elements extracted in step S121.

<Step S123> The table synchronization unit 151 determines whether or not a column corresponding to the column-corresponding element exists. Specifically, the table synchronization unit 151 determines whether or not the current matrix table has a column having the identifier (ID) of the column-corresponding element as a property. When yes is determined, the operation goes to step S125. When no is determined, the operation goes to step S124.

<Step S124> The table synchronization unit 151 produces a column corresponding to the column-corresponding element. Specifically, the table synchronization unit 151 adds a column to the position following the last column in the matrix table in the design-data table 121. In the case where no column has been set yet, the column is added at the starting position. At this time, ruled lines for the matrix table are set again. Subsequently, the table synchronization unit 151 sets the identifier (ID) of the column-corresponding element as a property of the added column. In addition, the table synchronization unit 151 acquires from the column-corresponding element the attribute value (character string) designated by the “colHeader” attribute of the <Matrix> element in the mapping definition 132, and sets the acquired attribute value in the leading cell in the column (i.e., the cell in the row to which the starting position belongs) as a column header.

<Step S125> When the processing in steps S123 and S124 is completed for all the column-corresponding elements, the operation goes to step S126.

<Step S126> The table synchronization unit 151 deletes one or more unnecessary columns from the matrix table in the worksheet. Specifically, when a column existing in the worksheet has an identifier (ID) of a column-corresponding element as a property, and none of the column-corresponding elements extracted in step S121 has the identifier (ID), the table synchronization unit 151 deletes the column. Thereafter, the table synchronization unit 151 sorts the columns in the matrix table into the order of the extracted column-corresponding elements, and the operation goes to step S127 in FIG. 26.

<Step S127> The table synchronization unit 151 extracts cell-corresponding elements. Specifically, the table synchronization unit 151 acquires from the sheet-corresponding element a set of model elements corresponding to the attribute designated by the “cellProperty” attribute in the <FromSheet> element. Subsequently, the table synchronization unit 151 extracts from the acquired set of model elements model elements of the type designated by the “cellPropertyKind”. The extracted model elements are the cell-corresponding elements.

<Step S128> The table synchronization unit 151 starts the processing in steps S129 to S131 for each of the cell-corresponding elements extracted in step S127.

<Step S129> The table synchronization unit 151 determines a row-corresponding element referred to by the cell-corresponding element. Specifically, the table synchronization unit 151 acquires a model element designated by the “rowProperty” attribute in the <FromSheet> element in the mapping definition 132, and determines the acquired model element to be the row-corresponding element referred to by the cell-corresponding element.

<Step S130> The table synchronization unit 151 determines a column-corresponding element referred to by the cell-corresponding element. Specifically, the table synchronization unit 151 acquires a model element designated by the “colProperty” attribute in the <FromSheet> element in the mapping definition 132, and determines the acquired model element to be the column-corresponding element referred to by the cell-corresponding element.

<Step S131> The table synchronization unit 151 sets a cell value. Specifically, the table synchronization unit 151 sets the value designated in the <Value> element in the mapping definition 132, in the cell at which a row corresponding to the row-corresponding element and a column corresponding to the column-corresponding element intersect, where both of the row-corresponding element and the column-corresponding element correspond to the cell-corresponding element. In addition, the table synchronization unit 151 sets the identifier (ID) of the cell-corresponding element as a property of the cell.

<Step S132> When the processing in steps S129 to S131 is completed for all the cell-corresponding elements, the operation goes to step S133.

<Step S133> The table synchronization unit 151 deletes one or more unnecessary cell values from the matrix table in the worksheet. Specifically, the table synchronization unit 151 searches for a cell having as a property an identifier (ID) of a cell-corresponding element which is not identical to the identifier (ID) of any of the cell-corresponding elements extracted in step S127. When the table synchronization unit 151 detects such a cell, the table synchronization unit 151 deletes a value set in the detected cell.

As described above, it is possible to synchronize a worksheet with a sheet-corresponding element.

### 3.5 Synchronization of Modeling Information with Design-data Table

Next, processing for synchronization of the modeling-information set 112 with the design-data table 123 is explained below. In this processing, only the operations for synchronizing a sheet-corresponding element with a worksheet are different from the first embodiment. That is, the operations performed in the second embodiment for reflecting the contents of design-data tables in modeling information, for synchronizing model elements with a table-storing directory, and for synchronizing a book-corresponding element with the book are respectively similar to the operations explained with reference to FIGS. 12 to 14. Therefore, only the processing for synchronizing a sheet-corresponding element with a worksheet is explained in detail below.

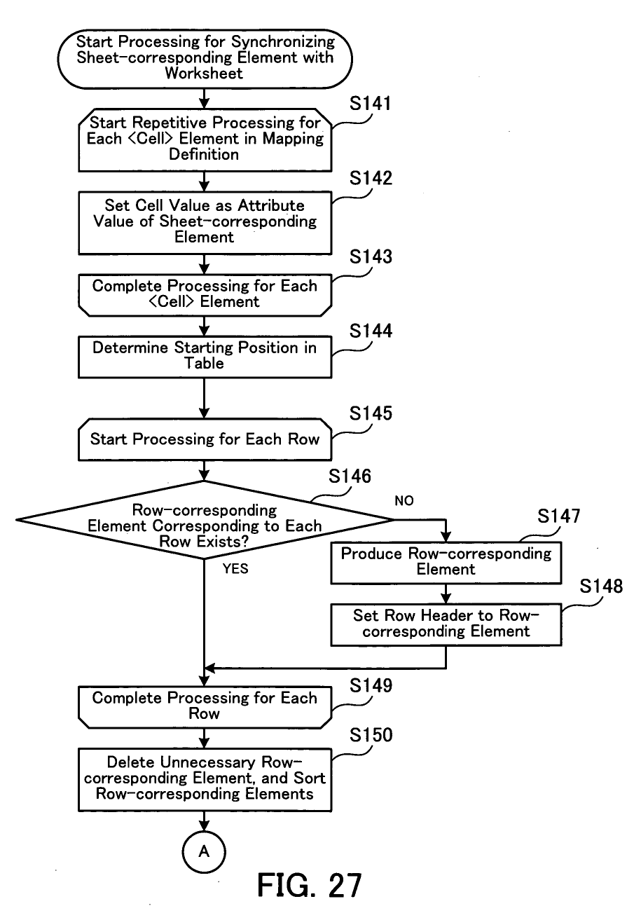

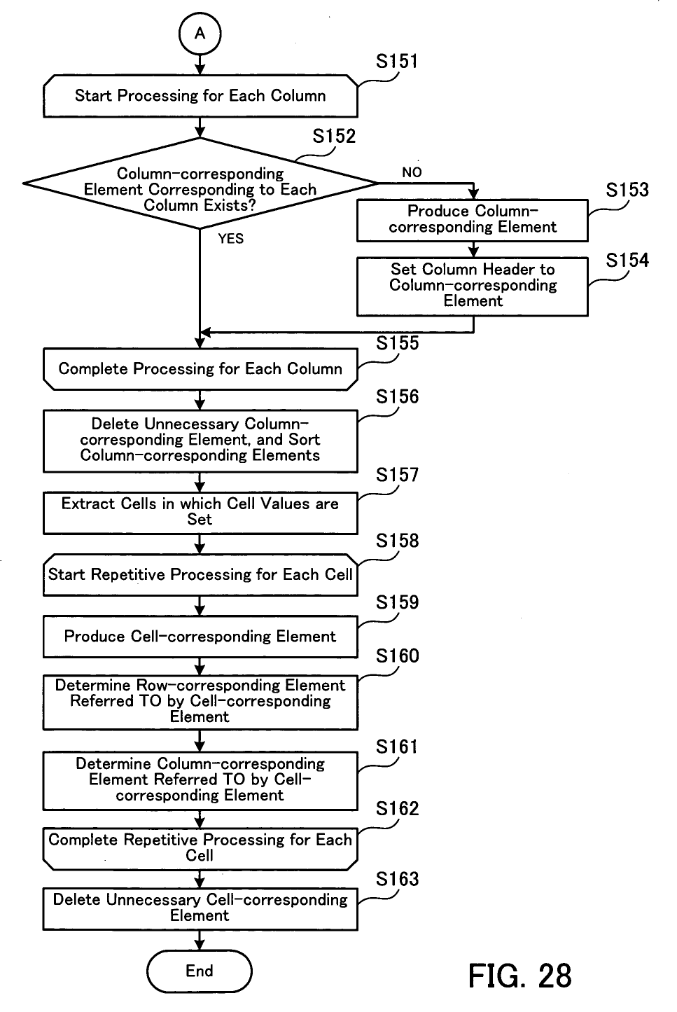

FIGS. 27 and 28 show a flow diagram indicating processing for synchronizing a sheet-corresponding element with a worksheet. The processing illustrated in FIGS. 27 and 28 is explained below step by step.

<Step S141> The model synchronization unit 152 repeatedly performs the processing in step S142 for each <Cell> element in the mapping definition 132.

<Step S142> The model synchronization unit 152 sets a cell value as a value of an attribute of a sheet-corresponding element. Specifically, the model synchronization unit 152 determines a cell in the worksheet on the basis of the column and row respectively designated by the attributes “templateCol” and “templateRow” in the <Cell> element. Subsequently, the model synchronization unit 152 sets the value currently set in the determined cell as a value of an attribute of the current sheet-corresponding element designated by the “property” attribute in the <Cell> element.

<Step S143> When the processing in step S142 is completed for all the <Cell> elements in the mapping definition 132, the operation goes to step S144.

<Step S144> The model synchronization unit 152 determines the starting position in the matrix table. Specifically, the model synchronization unit 152 determines the cell in the column and row respectively designated by the attributes “templateCol” and “templateRow” in the <Matrix> element to be the starting position in the matrix table.

<Step S145> The model synchronization unit 152 starts the processing in steps S146 to S148 for each row in the matrix table.

<Step S146> The model synchronization unit 152 determines whether or not a row-corresponding element corresponding to the row exists. Specifically, the model synchronization unit 152 determines whether or not the set of model elements owned by the sheet-corresponding element on the basis of the “rowProperty” attribute indicated in the <Matrix> element in the mapping definition 132 include a model element having an identifier (ID) which is set as a property of the row (as an identifier (ID) of a row-corresponding element). When yes is determined, the operation goes to step S149. When no is determined, the operation goes to step S147.

<Step S147> The model synchronization unit 152 produces a row-corresponding element corresponding to the row. Specifically, the model synchronization unit 152 adds a model element (row-corresponding element) to the set of model elements owned by the sheet-corresponding element on the basis of the attribute designated by the “rowProperty” attribute in the <Matrix> element in the mapping definition 132. The type of the added model element is designated by the “rowPropertyKind” attribute in the <Matrix> element. In addition, when the row-corresponding element is added to the modeling-information set 112, the modeling-tool interface 162 adds an identifier (ID) to the row-corresponding element for uniquely identifying the row-corresponding element. The model synchronization unit 152 receives from the modeling-tool interface 162 the identifier (ID) of the row-corresponding element, and sets the received identifier (ID) as a property of the row.

<Step S148> The model synchronization unit 152 sets a row header in the row-corresponding element. Specifically, the model synchronization unit 152 sets a character string (row header) currently set in the leading cell in the row (i.e., the cell in the row and in the column corresponding to the starting position in the matrix table), as a value of an attribute of the added row-corresponding element designated by the “rowHeader” attribute in the <Matrix> element in the mapping definition 132.

<Step S149> When the processing in steps S146 to S148 is completed for all the rows in the matrix table, the operation goes to step S150.

<Step S150> The model synchronization unit 152 deletes one or more unnecessary row-corresponding elements. Specifically, the model synchronization unit 152 deletes a model element from the set of model elements owned by the sheet-corresponding element on the basis of the attribute designated by the “rowProperty” attribute in the <Matrix> element in the mapping definition 132 when no row corresponding to the model element exists in the matrix table (i.e., when no model element in the matrix table has the same identifier (ID) as the row). Thereafter, the model synchronization unit 152 sorts the row-corresponding elements in the matrix table into the order of the rows in the matrix table, and the operation goes to step S151 in FIG. 28.

<Step S151> The model synchronization unit 152 starts the processing in steps S152 to S154 for each column in the matrix table.

<Step S152> The model synchronization unit 152 determines whether or not a column-corresponding element corresponding to the column exists. Specifically, the model synchronization unit 152 determines whether or not the set of model elements owned by the sheet-corresponding element on the basis of the “colProperty” attribute indicated in the <Matrix> element in the mapping definition 132 include a model element having an identifier (ID) which is set as a property of the column (as an identifier (ID) of a column-corresponding element) When yes is determined, the operation goes to step S155. When no is determined, the operation goes to step S153.

<Step S153> The model synchronization unit 152 produces a column-corresponding element corresponding to the column. Specifically, the model synchronization unit 152 adds a model element (column-corresponding element) to the set of model elements owned by the sheet-corresponding element on the basis of the attribute designated by the “colProperty” attribute in the <Matrix> element in the mapping definition 132. The type of the added model element is designated by the “colPropertyKind” attribute in the <Matrix> element. In addition, when the column-corresponding element is added to the modeling-information set 112, the modeling-tool interface 162 adds an identifier (ID) to the column-corresponding element for uniquely identifying the column-corresponding element. The model synchronization unit 152 receives from the modeling-tool interface 162 the identifier (ID) of the column-corresponding element, and sets the received identifier (ID) as a property of the column.

<Step S154> The model synchronization unit 152 sets a column header in the column-corresponding element. Specifically, the model synchronization unit 152 sets a character string (column header) currently set in the leading cell (i.e., the cell in the column and in the row corresponding to the starting position in the matrix table), as a value of an attribute of the added column-corresponding element designated by the “colHeader” attribute in the <Matrix> element in the mapping definition 132.

<Step S155> When the processing in steps S152 to S154 is completed for all the columns in the matrix table, the operation goes to step S156.

<Step S156> The model synchronization unit 152 deletes one or more unnecessary column-corresponding elements. Specifically, the model synchronization unit 152 deletes a model element from the set of model elements owned by the sheet-corresponding element on the basis of the attribute designated by the “colProperty” attribute in the <Matrix> element in the mapping definition 132 when no column corresponding to the model element exists in the matrix table (i.e., when no model element in the matrix table has the same identifier (ID) as the column). Thereafter, the model synchronization unit 152 sorts the column-corresponding elements in the matrix table into the order of the columns in the matrix table.

<Step S157> The model synchronization unit 152 extracts one or more cell values in the matrix table. Specifically, the model synchronization unit 152 extracts one or more of the cells (excluding the row headers and the column headers) of the matrix table in each of which the value designated in the <Value> element in the mapping definition 132 (i.e., the cell value) is set.

<Step S158> The model synchronization unit 152 starts the processing in steps S159 to S161 for each cell extracted in step S157.

<Step S159> The model synchronization unit 152 adds to the modeling-information set 112 a model element (cell-corresponding element) of the type designated by the “cellPropertyKind” attribute in the <FromSheet> element in the mapping definition 132, as a model element owned by the sheet-corresponding element on the basis of the attribute designated by the “cellProperty” attribute in the <FromSheet> element. In addition, when the cell-corresponding element is added to the modeling-information set 112, the modeling-tool interface 162 adds an identifier (ID) to the column-corresponding element for uniquely identifying the column-corresponding element. The model synchronization unit 152 receives from the modeling-tool interface 162 the identifier (ID) of the column-corresponding element, and sets the received identifier (ID) as a property of the cell.

<Step S160> The model synchronization unit 152 sets a row-corresponding element referred to by the cell-corresponding element. Specifically, the model synchronization unit 152 sets as the row-corresponding element corresponding to the row containing the cell, a model element referred to by the cell-corresponding element on the basis of the attribute designated by the “rowProperty” attribute in the <FromSheet> element in the mapping definition 132. When the attribute for referring to the row-corresponding element is already set, the operation of setting the row-corresponding element is not performed.

<Step S161> The model synchronization unit 152 sets a column-corresponding element referred to by the cell-corresponding element. Specifically, the model synchronization unit 152 sets as the column-corresponding element corresponding to the column containing the cell, a model element referred to by the cell-corresponding element on the basis of the attribute designated by the “rowProperty” attribute in the <FromSheet> element in the mapping definition 132. When the attribute for referring to the column-corresponding element is already set, the operation of setting the column-corresponding element is not performed.

<Step S162> When the processing in steps S159 to S161 is completed for all the cells having the cell value, the operation goes to step S163.

<Step S163> The model synchronization unit 152 deletes one or more unnecessary cell-corresponding elements. Specifically, the model synchronization unit 152 acquires the set of model elements owned by the sheet-corresponding element on the basis of the attribute designated by the “cellProperty” attribute in the <Matrix> element in the mapping definition 132, and determines one or more of the acquired model elements of the type designated by the “cellPropertyKind” in the <Matrix> element (i.e., one or more cell-corresponding elements) When no cell value (indicating the blank circle) is set in one or more cells corresponding to one or more of the model elements determined as above, the model synchronization unit 152 deletes the one or more cells.

As described above, it is possible to synchronize a sheet-corresponding element with a worksheet.

As described above, according to the second embodiment, the modeling-information set 112 and the design-data table 123 (in the matrix format) can be synchronized with each other.

### 4. Other Variations

Hereinbelow, some variations of the above embodiments are explained.

### 4.1 First Variation

In the first variation, the system-data-architecture management system using the list format according to the first embodiment and the system-data-architecture management system using the matrix format according to the second embodiment are combined. The mapping definitions 131 and 132 used in the system-data-architecture management systems in the first and second embodiments respectively contain the <Table> element and the <Matrix> element. Therefore, it is possible to combine the sequences of processing according to the first and second embodiments using the list format and the matrix format into a single sequence by adding a step of determining which of the <Table> element and the <Matrix> element is contained in the mapping definition.

Specifically, in the case where modeling information is reflected in a design-data table, a step of determining which of the <Table> element and the <Matrix> element is contained in the mapping definition is performed immediately after completion of the repetitive processing in accordance with the mapping definition in steps S41 to S43 in the sequence for synchronizing a worksheet with a sheet-corresponding element illustrated in FIG. 11. When the <Table> element is contained in the mapping definition, the processing in steps S44 to S52 according to the first embodiment using the list format is performed. When the <Matrix> element is contained in the mapping definition, the processing after step S113 in the sequence for synchronizing a worksheet with a sheet-corresponding element illustrated in FIGS. 25 and 26 is performed after the repetitive processing in accordance with the mapping definition in steps S41 to S43 (S111 to S113), i.e., the processing according to the second embodiment using the matrix format is performed.

In addition, in the case where a design-data table is reflected in modeling information, a step of determining which of the <Table> element and the <Matrix> element is contained in the mapping definition is also performed immediately after completion of the repetitive processing in accordance with the mapping definition in steps S91 to S93 in the sequence for synchronizing a sheet-corresponding element with a worksheet illustrated in FIG. 15. When the <Table> element is contained in the mapping definition, the processing in steps S94 to S102 according to the first embodiment using the list format is performed. When the <Matrix> element is contained in the mapping definition, the processing after step S143 in the sequence for synchronizing a sheet-corresponding element with a worksheet illustrated in FIGS. 27 and 28 is performed after the repetitive processing in accordance with the mapping definition in steps S91 to S93 (S141 to S143), so that the processing according to the second embodiment using the matrix format is performed.

### 4.2 Second Variation

The second variation can be applied to the case where generalization relationships exist as model elements which connect model elements.

As explained before, in the processing according to the second embodiment, a model structure representing a connection between two model elements (e.g., the model elements “Class 1” and “Class 2”) by arranging a model element (e.g., a dependency relationship) which refers to the two model elements as attribute values, as the “dependency relationship” in UML, is handled.

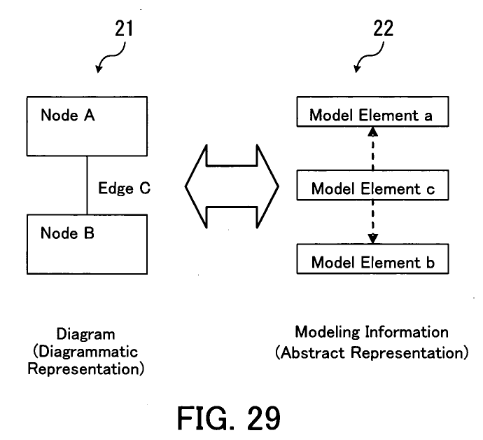

FIG. 29 is a diagram for showing correspondence between a diagrammatic representation 21 with nodes and an edge and an abstract model-structure representation 22 including a dependency relationship. In the diagrammatic representation 21, two nodes A and B are connected with an edge C. The abstract model-structure representation 22 contains model elements a, b, and c respectively corresponding to the nodes A and B and the edge C. In the case where the edge C represents a dependency relationship in UML, the model element c refers to the model elements a and b as attribute values according to the UML specification. However, in the case where the edge C represents a generalization relationship in UML, the corresponding model structure is different from the abstract model-structure representation 22.

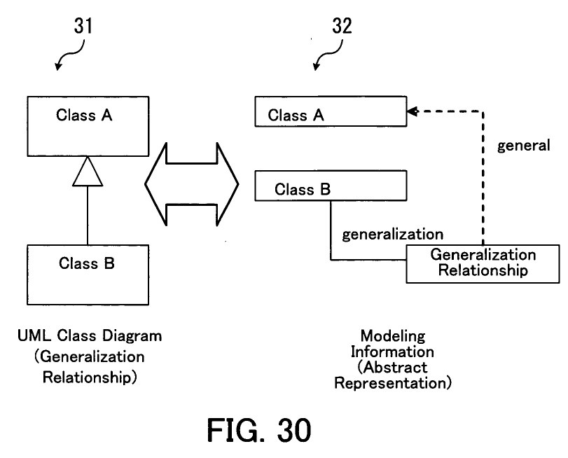

FIG. 30 is a diagram for showing correspondence between a UML class diagram 31 and an abstract model-structure representation 32 which indicate a generalization relationship. In the UML class diagram 31, the classes A and B are connected with an edge representing a generalization relationship. The generalization relationship represented in the UML class diagram 31 can be abstractly represented as the abstract model-structure representation 32 according to the UML specification. As illustrated in the abstract model-structure representation 32, the generalization relationship is owned as a value of the “generalization” attribute of the model element “Class B”, and refers to the model element “Class A” as a value of the “general” attribute.

The abstract model-structure representation 32 indicated in FIG. 30 resembles the diagram indicated in FIG. 18. Therefore, a demand for converting the modeling information indicated in the abstract model-structure representation 32 into a design-data table in the matrix format is likely to occur. However, since the model structures are different, it is impossible to use the mapping definition 132 indicated in FIG. 23 as it is.

In order to use the mapping definition for converting the modeling information indicated in the abstract model-structure representation 32 into a design-data table in the matrix format, the <FromSheet> element in the mapping definition 132 shown in FIG. 23 should be replaced with one of the following <FromRow> and <FromCol> elements.

(1) In order to associate a generalization relationship owned by a row-corresponding element with a cell in the matrix table, the <FromRow> element should be as follows.

```
  <FromRow cellProperty=“generalization”
cellPropertyKind=“Generalization”
    colProperty=“general”>
    <Value .../>
  <FromRow/>
```

(2) In order to associate a generalization relationship owned by a column-corresponding element with a cell in the matrix table, the <FromCol> element should be as follows.

```
  <FromCol cellProperty=“generalization”
cellPropertyKind=“Generalization”
    rowProperty=“general”>
    <Value .../>
  <FromCol/>
```

The above <FromRow> and <FromCol> elements are explained below in comparison with the <FromSheet> element.

Although the “cellProperty” attribute in the <FromSheet> element designates an attribute of the sheet-corresponding element, the “cellProperty” attribute in the <FromRow> element designates an attribute of the row-corresponding element, and the “cellProperty” attribute in the <FromCol> element designates an attribute of the column-corresponding element.

The “cellPropertyKind” attributes in the <FromRow> and <FromCol> elements are similar to the “cellPropertyKind” attribute in the <FromSheet> element, and designate the type of the model element corresponding to the “cellPropertyKind” attribute.

In addition, in the case where the <FromRow> element is used, the “rowProperty” attribute is unnecessary since the row-corresponding element referred to by the cell-corresponding element (as a value of the “cellProperty” attribute) is already determined. The “colProperty” attribute designates an attribute of the cell-corresponding element which refers to the column-corresponding element.

Further, in the case where the <FromCol> element is used, the “colProperty” attribute is unnecessary since the column-corresponding element referred to by the cell-corresponding element (as a value of the “cellProperty” attribute) is already determined. The “rowProperty” attribute designates an attribute of the cell-corresponding element which refers to the row-corresponding element.

### 4.3 Third Variation

In the third variation, the <Value> element is defined so that a value other than the fixed value is set. The <Value> element in the second embodiment designates a fixed value (the “fix” attribute) as the value to be set in the cell in the matrix table. On the other hand, in the third variation, the <Value> element is arranged to designate the “property” attribute instead of the “fix” attribute, so that it is possible to arbitrarily set the attribute values of the cell-corresponding elements (when modeling information is reflected in a design-data table), or arbitrarily set the cell values as the attribute values of the cell-corresponding elements (when a design-data table is reflected in modeling information).

### 5. Recording Medium Storing a Program

The above processing functions of the system-data-architecture management system can be realized by a computer. In this case, a program describing details of processing for realizing the functions which the data conversion unit 150 should have is provided. When the computer executes the program, the above processing functions can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium, or is initially transferred from the server computer. The computer reads the program from the storage device, and performs processing in accordance with the program. Alternatively, the computer may directly read the program from the portable recording medium for performing processing in accordance with the program. Further alternatively, the computer can sequentially execute processing in accordance with each portion of the program every time the portion of the program is transferred from the server computer.

### 6. Advantages and Additional Matter

According to the present invention, a mapping definition for mutual conversion between modeling information and a design-data table is provided, and both of synchronization of the modeling information with the design-data table and synchronization of the design-data table with the modeling information can be automatically performed in accordance with the mapping definition. Therefore, when the user arbitrarily chooses and edits a convenient one of the modeling information and the design-data table, the edited information can be reflected in both of the modeling information and the design-data table.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable medium storing a system-data-architecture management program which is executed by a computer and makes the computer realize a system-data-architecture management system for managing modeling information for diagrammatically representing relationships between data items used in a computer system and a design-data table representing the data items in a tabular form, said system-data-architecture management system comprising:
a modeling-information storing unit which stores said modeling information, where the modeling information defines a data architecture by using model elements, attribute values can be set in the model elements on an attribute-by-attribute basis, and an identifier for uniquely identifying each of the model elements is set to said each of the model elements;
a table storing unit for storing a design-data table which has at least one row and at least one column, wherein said model elements are associated with only the at least one row, or only the at least one column, or both the at least one row and the at least one column, cells are arrayed in the at least one row or the at least one column with which the model elements are associated, and values corresponding to attributes related to said the model elements are set in the cells;
a mapping-definition storing unit which stores a mapping definition including a synchronized-element definition, a synchronized-attribute definition, and a table-structure definition, where the synchronized-element definition defines all or a part of said model elements as one or more model elements to be synchronized with said design-data table, the synchronized-attribute definition defines all or a part of said attributes as one or more attributes to be synchronized with the design-data table, and the table-structure definition defines a table structure used in tabulating values corresponding to the one or more attributes for each of the one or more model elements;
a table synchronization unit which extracts said one or more model elements from said modeling information on the basis of said synchronized-element definition, determines, according to said table-structure definition, one or more of said at least one row and said at least one column in the design-data table with which the one or more model elements are respectively associated, sets one or more identifiers of the one or more model elements to said one or more of the at least one row and the at least one column, extracts one or more first attribute values of all or a first part of said one or more attributes set in the one or more model elements, and sets one or more values corresponding to the one or more first attribute values in one or more cells arrayed in said one or more of the at least one row and the at least one column, in accordance with the table-structure definition, when a request for synchronization of the design-data table with the modeling information is inputted into said computer; and
a model synchronization unit which determines said one or more of the at least one row and the at least one column according to said table-structure definition, determines all or a second part of said one or more attributes to correspond to said one or more cells, according to the table-structure definition, determines one or more second attribute values of all or said second part of the one or more attributes on the basis of values set in the one or more cells, and sets one of the one or more second attribute values of all or said second part of the one or more attributes corresponding to each of said one or more cells in one of said one or more model elements so that said each of the one or more cells is located in one of said one or more of the at least one row and the at least one column to which an identifier corresponding to the one of said one or more model elements is set, when a request for synchronization of the modeling information with the design-data table is inputted into said computer.

2. The computer-readable medium according to claim 1, wherein said system-data-architecture management system further comprises a table-template storing unit which stores a table template as a template of the design-data table, and said table synchronization unit produces the design-data table by copying the table template into said table storing unit when said table storing unit does not store the design-data table.

3. The computer-readable medium according to claim 1, wherein:
said mapping definition defines as said table-structure definition an array of said one or more attributes which indicates correspondence between said one or more attributes and said one or more cells;
said table synchronization unit determines correspondence between said one or more first attribute values and all or a part of said one or more cells on the basis of said array, and sets the one or more first attribute values in said one or more cells, after the table synchronization unit extracts the one or more first attribute values; and
said model synchronization unit which determines all or said second part of said one or more attributes to correspond to said one or more cells, according to the table-structure definition, determines said one or more second attribute values of all or said second part of the one or more attributes, and sets in said one of the one or more model elements one of the values set in said each of the one or more cells as said one of the one or more second attribute values.

4. The computer-readable medium according to claim 1, wherein:
the synchronized-element definition defines all or a part of said model elements as two or more model elements to be synchronized with said design-data table, and said modeling information stored in said modeling-information storing unit includes an attribute of each of said model elements for designating another of the model elements related to said each of the model elements,
said table-structure definition in said mapping definition stored in said mapping-definition storing unit associates the model elements with said at least one row and said at least one column, and designates to set in each cell located at an intersection of one of said at least one row and one of said at least one column a value indicating presence or absence of a more model element which is to be synchronized with the design-data table and is related to both of one of the two or more model elements associated with the one of the at least one row and one of the two or more model elements associated with the one of the at least one column,
said table synchronization unit determines, according to said table-structure definition, one or more rows and one or more columns in the design-data table with which said two or more model elements are respectively associated, and sets a predetermined value in each cell located at an intersection of one of the one or more rows and one of the one or more columns when one of the two or more model elements is related to both of one of the two or more model elements associated with the one of the one or more rows and one of the two or more model elements associated with the one of the one or more columns, and
said model synchronization unit detects one or more cells in said design-data table in which said predetermined value is set, detects two of said two or more model elements from said modeling information on the basis of an identifier set to a row in which each of the one or more cells is located and an identifier set to a column in which said each of the one or more cells is located, and adds to the modeling information a model element which is to be synchronized with the design-data table and is related to both of the two of said two or more model elements.

5. The computer-readable medium according to claim 1, wherein said model synchronization unit adds to said modeling information a model element which is to be synchronized with the design-data table, and sets to a row or column an identifier which is set in the added model element, when no identifier is set to the row or column.

6. The computer-readable medium according to claim 1, wherein said table synchronization unit deletes from said design-data table one of said at least one row and said at least one column in the design-data table with which the one or more model elements are respectively associated, when no identifier of one of said one or more model elements is set to the one of said at least one row and said at least one column.

7. The computer-readable medium according to claim 1, wherein said model synchronization unit deletes from said modeling information a model element which is to be synchronized with the design-data table and does not correspond to any identifier set to one of a row or column associated with one of said one or more model elements.

8. The computer-readable medium according to claim 1, wherein said modeling information stored in said modeling-information storing unit includes at least one attribute of at least one of said model elements for designating another of said model elements related to each of the at least one of said model elements,
said synchronized-element definition in said mapping definition stored in said mapping-definition storing unit defines as one of said one or more model elements a model element which can be traced from one of the model elements as a starting model element through one or more relationships between two or more model elements by using one or more attributes, and
said table synchronization unit receives information designating said starting model element, which is inputted into said computer together with said request for synchronization of the modeling information with the design-data table, and said table synchronization unit traces the model element from the starting model element through the one or more relationships between the two or more model elements by using said at least one attribute.

9. A system-data-architecture management system for managing modeling information for diagrammatically representing relationships between data items used in a computer system and a design-data table representing the data items in a tabular form, comprising:
a modeling-information storing unit which stores said modeling information, where the modeling information defines a data architecture by using model elements, attribute values can be set in the model elements on an attribute-by-attribute basis, and an identifier for uniquely identifying each of the model elements is set to said each of the model elements;
a table storing unit for storing a design-data table which has at least one row and at least one column, wherein said model elements are associated with only the at least one row, or only the at least one column, or both the at least one row and the at least one column, cells are arrayed in the at least one row or the at least one column with which the model elements are associated, and values corresponding to attributes related to said the model elements are set in the cells;
a mapping-definition storing unit which stores a mapping definition including a synchronized-element definition, a synchronized-attribute definition, and a table-structure definition, where the synchronized-element definition defines all or a part of said model elements as one or more model elements to be synchronized with said design-data table, the synchronized-attribute definition defines all or a part of said attributes as one or more attributes to be synchronized with the design-data table, and the table-structure definition defines a table structure used in tabulating values corresponding to the one or more attributes for each of the one or more model elements;
a table synchronization unit which extracts said one or more model elements from said modeling information on the basis of said synchronized-element definition, determines, according to said table-structure definition, one or more of said at least one row and said at least one column in the design-data table with which the one or more model elements are respectively associated, sets one or more identifiers of the one or more model elements to said one or more of the at least one row and the at least one column, extracts one or more first attribute values of all or a first part of said one or more attributes set in the one or more model elements, and sets one or more values corresponding to the one or more first attribute values in one or more cells arrayed in said one or more of the at least one row and the at least one column, in accordance with the table-structure definition, when a request for synchronization of the design-data table with the modeling information is inputted into said computer; and
a model synchronization unit which determines said one or more of the at least one row and the at least one column according to said table-structure definition, determines all or a second part of said one or more attributes to correspond to said one or more cells, according to the table-structure definition, determines one or more second attribute values of all or said second part of the one or more attributes on the basis of values set in the one or more cells, and sets one of the one or more second attribute values of all or said second part of the one or more attributes corresponding to each of said one or more cells in one of said one or more model elements so that said each of the one or more cells is located in one of said one or more of the at least one row and the at least one column to which an identifier corresponding to the one of said one or more model elements is set, when a request for synchronization of the modeling information with the design-data table is inputted into said computer.

10. The system-data-architecture management system according to claim 9, wherein said system-data-architecture management system further comprises a table-template storing unit which stores a table template as a template of the design-data table, and said table synchronization unit produces the design-data table by copying the table template into said table storing unit when said table storing unit does not store the design-data table.

11. The system-data-architecture management system according to claim 9, wherein:
said mapping definition defines as said table-structure definition an array of said one or more attributes which indicates correspondence between said one or more attributes and said one or more cells;
said table synchronization unit determines correspondence between said one or more first attribute values and all or a part of said one or more cells on the basis of said array, and sets the one or more first attribute values in said one or more cells, after the table synchronization unit extracts the one or more first attribute values; and
said model synchronization unit which determines all or said second part of said one or more attributes to correspond to said one or more cells, according to the table-structure definition, determines said one or more second attribute values of all or said second part of the one or more attributes, and sets in said one of the one or more model elements one of the values set in said each of the one or more cells as said one of the one or more second attribute values.

12. The system-data-architecture management system according to claim 9, wherein:
the synchronized-element definition defines all or a part of said model elements as two or more model elements to be synchronized with said design-data table, and said modeling information stored in said modeling-information storing unit includes an attribute of each of said model elements for designating another of the model elements related to said each of the model elements;
said table-structure definition in said mapping definition stored in said mapping-definition storing unit associates the model elements with said at least one row and said at least one column, and designates to set in each cell located at an intersection of one of said at least one row and one of said at least one column a value indicating presence or absence of a more model element which is to be synchronized with the design-data table and is related to both of one of the two or more model elements associated with the one of the at least one row and one of the two or more model elements associated with the one of the at least one column;
said table synchronization unit determines, according to said table-structure definition, one or more rows and one or more columns in the design-data table with which said two or more model elements are respectively associated, and sets a predetermined value in each cell located at an intersection of one of the one or more rows and one of the one or more columns when one of the two or more model elements is related to both of one of the two or more model elements associated with the one of the one or more rows and one of the two or more model elements associated with the one of the one or more columns; and
said model synchronization unit detects one or more cells in said design-data table in which said predetermined value is set, detects two of said two or more model elements from said modeling information on the basis of an identifier set to a row in which each of the one or more cells is located and an identifier set to a column in which said each of the one or more cells is located, and adds to the modeling information a model element which is to be synchronized with the design-data table and is related to both of the two of said two or more model elements.

13. The system-data-architecture management system according to claim 9, wherein said model synchronization unit adds to said modeling information a model element which is to be synchronized with the design-data table, and sets to a row or column an identifier which is set in the added model element, when no identifier is set to the row or column.

14. The system-data-architecture management system according to claim 9, wherein said table synchronization unit deletes from said design-data table one of said at least one row and said at least one column in the design-data table with which the one or more model elements are respectively associated, when no identifier of one of said one or more model elements is set to the one of said at least one row and said at least one column.

15. The system-data-architecture management system according to claim 9, wherein said model synchronization unit deletes from said modeling information a model element which is to be synchronized with the design-data table and does not correspond to any identifier set to one of a row or column associated with one of said one or more model elements.

16. The system-data-architecture management system according to claim 9, wherein:
said modeling information stored in said modeling-information storing unit includes at least one attribute of at least one of said model elements for designating another of said model elements related to each of the at least one of said model elements;
said synchronized-element definition in said mapping definition stored in said mapping-definition storing unit defines as one of said one or more model elements a model element which can be traced from one of the model elements as a starting model element through one or more relationships between two or more model elements by using one or more attributes; and
said table synchronization unit receives information designating said starting model element, which is inputted into said computer together with said request for synchronization of the modeling information with the design-data table, and said table synchronization unit traces the model element from the starting model element through the one or more relationships between the two or more model elements by using said at least one attribute.

17. A system-data-architecture management process for managing modeling information for diagrammatically representing relationships between data items used in a computer system and a design-data table representing the data items in a tabular form, comprising the steps of:
(a) preparing in advance in said computer,
a modeling-information storing unit which stores said modeling information, where the modeling information defines a data architecture by using model elements, attribute values can be set in the model elements on an attribute-by-attribute basis, and an identifier for uniquely identifying each of the model elements is set to said each of the model elements,
a table storing unit for storing a design-data table which has at least one row and at least one column, and wherein said model elements are associated with only the at least one row, or only the at least one column, or both the at least one row and the at least one column, cells are arrayed in the at least one row or the at least one column with which the model elements are associated, and values corresponding to attributes related to said the model elements are set in the cells, and
a mapping-definition storing unit which stores a mapping definition including a synchronized-element definition, a synchronized-attribute definition, and a table-structure definition, where the synchronized-element definition defines all or a part of said model elements as one or more model elements to be synchronized with said design-data table, the synchronized-attribute definition defines all or a part of said attributes as one or more attributes to be synchronized with the design-data table, and the table-structure definition defines a table structure used in tabulating values corresponding to the one or more attributes for each of the one or more model elements;
(b) performing, by a table synchronization unit, first processing for synchronizing the design-data table with the modeling information when a request for synchronization of the design-data table with the modeling information is inputted into said computer, where the first processing includes the substeps of,
(b1) extracting said one or more model elements from said modeling information on the basis of said synchronized-element definition,
(b2) determining, according to said table-structure definition, one or more of said at least one row and said at least one column in the design-data table with which the one or more model elements are respectively associated,
(b3) setting one or more identifiers of the one or more model elements to said one or more of the at least one row and the at least one column,
(b4) extracting one or more first attribute values of all or a first part of said one or more attributes set in the one or more model elements, and
(b5) setting one or more values corresponding to the one or more first attribute values in one or more cells arrayed in said one or more of the at least one row and the at least one column, in accordance with the table-structure definition; and
(c) performing, by a model synchronization unit, second processing for synchronizing the modeling information with the design-data table when a request for synchronization of the modeling information with the design-data table is inputted into said computer, where the second processing includes the substeps of,
(c1) determining said one or more of the at least one row and the at least one column according to said table-structure definition,
(c2) determining all or a second part of said one or more attributes to correspond to said one or more cells, according to the table-structure definition,
(c3) determining one or more second attribute values of all or said second part of the one or more attributes on the basis of values set in the one or more cells, and
(c4) setting one of the one or more second attribute values of all or said second part of the one or more attributes corresponding to each of said one or more cells in one of said one or more model elements so that said each of the one or more cells is located in one of said one or more of the at least one row and the at least one column to which an identifier corresponding to the one of said one or more model elements is set.

18. The system-data-architecture management process according to claim 17, wherein said system-data-architecture management system further comprises a table-template storing unit which stores a table template as a template of the design-data table, and said table synchronization unit produces the design-data table by copying the table template into said table storing unit when said table storing unit does not store the design-data table.

19. The system-data-architecture management process according to claim 17, wherein:
said mapping definition defines as said table-structure definition an array of said one or more attributes which indicates correspondence between said one or more attributes and said one or more cells;
said table synchronization unit determines correspondence between said one or more first attribute values and all or a part of said one or more cells on the basis of said array, and sets the one or more first attribute values in said one or more cells, after the table synchronization unit extracts the one or more first attribute values; and
said model synchronization unit which determines all or said second part of said one or more attributes to correspond to said one or more cells, according to the table-structure definition, determines said one or more second attribute values of all or said second part of the one or more attributes, and sets in said one of the one or more model elements one of the values set in said each of the one or more cells as said one of the one or more second attribute values.

20. The system-data-architecture management process according to claim 17, wherein:
the synchronized-element definition defines all or a part of said model elements as two or more model elements to be synchronized with said design-data table, and said modeling information stored in said modeling-information storing unit includes an attribute of each of said model elements for designating another of the model elements related to said each of the model elements;
said table-structure definition in said mapping definition stored in said mapping-definition storing unit associates the model elements with said at least one row and said at least one column, and designates to set in each cell located at an intersection of one of said at least one row and one of said at least one column a value indicating presence or absence of a more model element which is to be synchronized with the design-data table and is related to both of one of the two or more model elements associated with the one of the at least one row and one of the two or more model elements associated with the one of the at least one column;
said table synchronization unit determines, according to said table-structure definition, one or more rows and one or more columns in the design-data table with which said two or more model elements are respectively associated, and sets a predetermined value in each cell located at an intersection of one of the one or more rows and one of the one or more columns when one of the two or more model elements is related to both of one of the two or more model elements associated with the one of the one or more rows and one of the two or more model elements associated with the one of the one or more columns; and
said model synchronization unit detects one or more cells in said design-data table in which said predetermined value is set, detects two of said two or more model elements from said modeling information on the basis of an identifier set to a row in which each of the one or more cells is located and an identifier set to a column in which said each of the one or more cells is located, and adds to the modeling information a model element which is to be synchronized with the design-data table and is related to both of the two of said two or more model elements.
